(19) United States
(12) Patent Application Publication
(10) Pub. No.: US 2016/0224734 A1
(43) Pub. Date: Aug. 4, 2016

(54) SYSTEMS AND METHODS FOR PALLIATIVE CARE

(71) Applicant: CERNER INNOVATION, INC., Kansas City, KS (US)

(72) Inventors: Hugh Ryan, Lee's Summit, MO (US); Phil Stadler, Olathe, KS (US); Frank Azzaro, Olathe, KS (US)

(21) Appl. No.: 14/985,566

(22) Filed: Dec. 31, 2015

Related U.S. Application Data
(60) Provisional application No. 62/098,885, filed on Dec. 31, 2014.

(51) Int. Cl. G06F 19/00

(52) U.S. Cl. CPC G06F 19/322; G06F 19/345

(57) ABSTRACT

Decision support services relating to palliative care are provided including identifying patients who potentially would benefit from a palliative care program, providing palliative care to a population of patients, and managing care of the population. Patients may be identified using a combination of patient-centric data and evidence-based logic to determine patients who likely qualify for palliative care. The identified patients may be stratified or subdivided into one or more categories, so that corresponding palliative care programs may be identified and patient care may be prioritized. These identified patients may then be matched with suitable health care providers. Additional palliative care services are described for generating palliative care workflows, patient worklists, managing patient transitions, referrals, and assignments.

### CROSS-REFERENCE TO RELATED APPLICATIONS

This application claims the benefit of U.S. Provisional Application No. 62/098,885, titled “Systems and Methods for Palliative Care,” filed Dec. 31, 2014, which is hereby expressly incorporated by reference in its entirety.

### BACKGROUND

Palliative Care is an area of health care that focuses on relieving & preventing the suffering of patients. It is an approach that improves the quality of life of patients and their families facing the problem associated with life-threatening illness, through the prevention and relief of suffering by means of early identification and impeccable assessment and treatment of pain and other problems, physical, psychosocial and spiritual. Unlike Hospice, palliative care is appropriate for patients in all disease stages and leverages a multi-disciplinary approach to patient care, addressing physical, emotional, spiritual and social concerns.

Palliative Care is positioned to play a critical role in efforts to redirect health care in order to establish effective, efficient patient-centered care; increasing quality while reducing the overall health care spend. There are approximately 90 million Americans living with serious & life-threatening illness and this number is expected to more than double over the next 25 years. This very population of seriously ill people constitute only 5-10% of the nation, but account for more than 50% of our national health care expenditure. Despite having the highest per capita spending on health care in the world, seriously ill people often do not receive the highest quality care, but represent a portion of our population who can benefit most from coordinated care across the continuum.

But as an adjunct to care options for those suffering from long-term or terminal disease processes, Palliative Care is a relatively new ‘medical service and specialty’. This emerging specialty is in need of increased recognition as it works to define a consistency of ‘best practice’ for practitioners and patients alike. In particular, meaningful approaches for performance improvement programs are needed capable of leveraging assets of EMR systems and cloud-based architectures and computing intelligence. Furthermore, for those patients receiving palliative care, having a trusted and stable system supporting their needs is essential to care consistency. Currently, no offerings exist that allow providers of palliative to be synchronized with their patients and care team within an acute care facility. Likewise, the care of a palliative care patient extends across the care continuum to feature care beyond the hospital setting.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The present invention is defined by the claims.

Embodiments of the present invention are directed to methods, computer systems, and computer storage media for providing decision support services relating to palliative care (“PC”), including identifying those patients that potentially would benefit from PC, providing PC to a population of patients, and managing care of the population. In brief and at a high level, embodiments of the invention are described herein for identifying patients who qualify for PC, but are otherwise unaccounted. The patients may be identified at earlier stages of need, thereby reducing unnecessary expenses and suffering. Some embodiments use a combination of patient-centric data and evidence-based logic to determine patients who likely qualify for PC. These identified patients may then be matched with suitable health care providers. Thus some embodiments of the invention further include identifying matching health care providers for providing PC to the patients.

In particular, some embodiments use the Cerner® Healthe Intent® platform (or similar platforms or other native transaction systems) to position one or more PC-patient identification algorithms and predictive models to “find” appropriate, qualifying patients and match them with appropriate providers. In some embodiments of these algorithms, assignment logic is applied. Moreover, some embodiments further include determining particular patient care needs and recommending patient care pathways, including PC pathways. For example, in an embodiment, one or more rules or software agents from Healthe Intent (or native transaction systems) are utilized to determine particular patient care needs and to recommend corresponding PC pathways, as well as to assist health care providers with plans of care and decision support. In this way, embodiments of the invention enable health care providers to be assisted, within their appropriate venues, by having plans of care to outline care needs as well as access to decision support advisors to triangulate best practice evidence, with real-time patient information and clinician engagement to help stratify and apply care needs.

Some embodiments of the invention facilitate providing consistency in care for PC patients. For example, as a person enters a palliative care program, consistency may be maintained by standardized assessments and appropriate care planning will ensue. This is the case for those patients not only in acute care settings, but also for those in long term care (LTC), a skilled nursing facility (SNF), or home and ambulatory care, and applies to their immediate care needs as well as documentation and utilization of advanced care directives.

Additionally, some embodiments of the invention may be used for predicting the needs and impact of PC services in the community. For example, some embodiments may be leveraged at the health care facility level or network level for determining resource demand, staffing, education, or similar needs. Such embodiments also may be used for predicting across a population, those who may qualify for PC care. These embodiments of the invention also facilitate managing the effects of supply/demand planning and provider workflows.

Additionally still, embodiments of the invention are provided for managing PC population(s) of patients. In particular, in one embodiment, a PC group may be managed via one or more worklists, population/facility/provider analytics, and/or reconciliation and assignment algorithms. Using some of these embodiments, health care providers are able to manage and care for their patients in a coordinated and consistent manner using EMR tools such as PC specific worklists, plans of care content, real-time/near-real-time decision support, which may be implemented using one or more computer health care programs, routines, or agents. Moreover, such applications can serve to monitor morbidity/mortality outcomes, costs, and key performance indicators for a given population.

### BRIEF DESCRIPTION OF THE DRAWINGS

Embodiments are described in detail below with reference to the attached drawing figures, wherein:

FIGS. 1A and 1B depict aspects of an illustrative operating environment suitable for practicing an embodiment of the invention.

FIG. 2 depicts a block diagram of one example computing architecture suitable for implementing an embodiment of the invention;

FIG. 3A depicts a flow diagram illustrating aspects of a method for identifying patients who qualify for PC, in accordance with an embodiment of the invention;

FIGS. 3B-3C depict a flow diagram illustrating a method for a PC identification algorithm, in accordance with an embodiment of the invention;

FIGS. 3D-3F depict a flow diagram illustrating a method for PC stratification, in accordance with an embodiment of the invention;

FIG. 3G depicts a flow diagram illustrating a method for PC prediction, in accordance with an embodiment of the invention;

FIG. 4A depicts a flow diagram illustrating aspects of a method for implementing a PC program, in accordance with an embodiment of the invention;

FIG. 4B depicts a user interface for significant events associated with a PC program, in accordance with an embodiment of the invention;

FIGS. 4C-4E depict example user interfaces showing IPOC PC workflows, in accordance with an embodiment of the invention;

FIG. 4F depicts an example user interface for PC intervention for complex CDS, in accordance with an embodiment of the invention;

FIG. 4G depicts an example user interface for a patient portal, in accordance with an embodiment of the invention;

FIGS. 4H-4I depicts a flow diagram illustrating aspects of a method for PC patient transition management, in accordance with an embodiment of the invention;

FIG. 4J depicts a flow diagram illustrating aspects of a method for PC referral need, in accordance with an embodiment of the invention;

FIG. 4K depicts a flow diagram illustrating aspects of a method for PC assignment, in accordance with an embodiment of the invention;

FIG. 5A depicts a flow diagram illustrating aspects of a method for managing a PC population of patients, in accordance with an embodiment of the invention;

FIGS. 5B-5D depicts aspects of worklists for managing patients, in accordance with an embodiment of the invention; and

FIG. 6 depicts one example of a PC workflow, in accordance with an embodiment of the invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various terms are used throughout this description. A full definition of any term can only be gleaned by giving consideration to the full breadth of this document. However, descriptions of some of these terms are included below to provide a clearer understanding of the ideas disclosed herein:

The terms chronic and/or complex condition generally refers to a biological or physical condition where the natural evolution of the condition can significantly impact a person's overall quality of life, including an irreversible inability to perform basic physical and social functions. Serious and persistent chronic conditions can be multidimensional, interdependent, complex and ongoing, characterized by a persistent and reoccurring health consequences lasting for an extended period of time.

The term coordination of care generally refers to an approach in which all members of the medical team work together to plan for a patient's care in the hospital and for discharge.

The term do not resuscitate (DNR) order generally refers to a physician's order not to attempt CPR if a patient's heart or breathing stops. The order may be written at the request of the patient or family, but it must be signed by a physician to be valid. There are separate versions for home and hospital.

The term advance directive generally refers to written or verbal instructions for your care if you are unable to make decisions.

The term durable power of attorney for healthcare generally refers to a document that designates the person you trust to make medical decisions on your behalf if you are unable.

The term living will generally refers to a document stating a patient's wishes regarding medical treatments.

The term end of life generally refers to the part of life where a person is living with, and impaired by, an eventually fatal condition, even if the prognosis is ambiguous or unknown.

The term holistic generally refers to a whole made up of interdependent parts. When applied to the treatment of illness, it is called holistic medicine and may include a number of factors, such as dealing with the root cause of an illness, increasing patient involvement and considering both conventional and complementary therapies.

The term home care generally refers to services provided in the home, such as nursing and physical therapy.

The term life prolonging treatment generally refers to medical treatments that aim to cure or remedy an illness.

The term long-term care generally refers to care that supports patients with chronic impairment for an indefinite period of time; it is provided in nursing facilities, at home or in the community.

The term multidisciplinary team generally refers to a group of caregivers comprising a mix of health care disciplines. Team members share common goals collaborate and work together in planning and delivery of care. Members might include general practitioners (GPs), surgeons, medical or radiation oncologists, palliative care specialists, pastoral care workers, social workers, nurses, occupational therapists, dieticians, volunteers, pharmacists or care assistants.

The term nonsteroidal anti-inflammatory drugs (NSAIDs) generally refers to a class of pain medications such as ibuprofen and aspirin, and the term opioids generally refers to a class of pain medications that have some opiate narcotic properties but are not derived from opium.

The term palliate generally means relieving the symptoms of a disease or disorder.

The term percutaneous endoscopic gastrostomy (PEG) generally refers to a surgical procedure for inserting a tube into the stomach to provide nutrition and hydration.

The term subacute care generally refers to short-term care in a nursing facility, usually for physical therapy.

The term terminal condition generally refers to a progressive condition that has no known or expected cure and that can be reasonably expected to cause the death of a person within a foreseeable future. Terminal conditions may include both malignant and non-malignant illness and aging.

Accordingly, aspects of the technology described herein are directed to, among other things, providing decision support services relating to palliative care (“PC”), including identifying those patients that potentially would benefit from a PC program, providing PC to a population of patients, and managing care of one or more PC-patient populations. In brief and at a high level, embodiments of the invention are described herein for identifying patients who qualify for PC, but are otherwise unaccounted. The patients may be identified at earlier stages of need, thereby reducing unnecessary expenses and suffering. Some embodiments use a combination of patient-centric data and evidence-based logic to determine patients who likely qualify for PC. These identified patients may then be matched with suitable health care providers. Thus some embodiments of the invention further include identifying matching health care providers for providing PC to the patients.

In particular, some embodiments use the Cerner® Healthe Intent® platform (or similar platforms or other native transaction systems) to position one or more PC-patient identification algorithms and predictive models to identify appropriate, qualifying patients and match them with appropriate providers. In some embodiments of these algorithms, assignment logic is applied. Moreover, some embodiments further include determining particular patient care needs and recommending patient care pathways, including PC pathways. For example, in an embodiment, one or more rules or software agents from Healthe Intent (or native transaction systems) are utilized to determine particular patient care needs and to recommend corresponding PC pathways, which may be embodied as health care computer software programs, routines, or agents, as well as to assist health care providers with plans of care and decision support. In this way, embodiments of the invention enable health care providers to be assisted, within their appropriate venues, by having plans of care to outline care needs as well as access to decision support advisors to triangulate best practice evidence, with real-time patient information and clinician engagement to help stratify and apply care needs.

Some embodiments of the invention also facilitate providing consistency in care for PC patients. For example, as a person enters a palliative care program, consistency may be maintained by standardized assessments and appropriate care planning will ensue. This is the case for those patients not only in acute care settings, but also for those in long term care (LTC), a skilled nursing facility (SNF), or home and ambulatory care, and applies to their immediate care needs as well as documentation and utilization of advanced care directives.

Additionally, some embodiments of the invention may be used for predicting the needs and impact of PC services in the community. For example, some embodiments may be leveraged at the health care facility level or network level for determining resource demand, staffing, education, or similar needs. Such embodiments also may be used for predicting across a population, those who may qualify for PC care. These embodiments of the invention also facilitate managing the effects of supply/demand planning and provider workflows. In this way, embodiments of the invention using PC programs in conjunction with healthcare IT (HIT) tools, applications and logic not only provide consistency, increased awareness and monitoring, and efficiencies within a single care venue, but by applying this across care environments and longitudinally to the care of an individual, wholesale improvements in care will be enabled, managed and measured.

Additionally still, embodiments of the invention are provided for managing PC population(s) of patients. In particular, in one embodiment, a PC group may be managed via one or more worklists, population/facility/provider analytics, and/or reconciliation and assignment algorithms. Using some of these embodiments, health care providers are able to manage and care for their patients in a coordinated and consistent manner using EMR tools such as PC specific worklists, plans of care content, real-time/near-real-time decision support. Moreover, such applications can serve to monitor morbidity/mortality outcomes, costs, and key performance indicators for a given population.

Some embodiments of the invention utilize cloud computing assets, longitudinal person records, and complex algorithmic and predictive model logic to enable palliative care professionals and care teams to communicate more efficiently, have greater awareness of changes to best practices and supporting care evidence, recognize individuals suitable for care, and better organize care planning and provide consistent care for qualified patients. In this way, these embodiments of the invention in turn reduce unnecessary expenses (e.g., ICU stays) and hospitalization (as well as concomitant error associated with hospitalization), while improving quality of life for persons receiving palliative care. Further, some embodiments further enable adjacent care processes (e.g., hospice, end-of-life planning), programs related to complex/high cost conditions (trauma care, oncology, etc.) and population health management.

Moreover, various embodiments of the invention provide additional advantages including: increasing the identification of patients who are in the early stages of a serious illness who would benefit from palliative care; improving the effectiveness and comfort level of primary care clinicians in communicating the necessity and benefits of palliative care with those patients with a serious illness; improving the assessment of the identified patient's palliative care needs, utilizing the domains of palliative care; increase the percentage of patients in the early stages of a serious illness who have a care plan identified and/or documented; improving the ongoing reassessment and adjustment of the patient's plan of care as the condition warrants, utilizing the domains of palliative care; and increasing the completion, documentation and ongoing utilization of advance directives for patients with a serious illness.

Accordingly, in one embodiment, the present invention is directed toward one or more computer storage media having computer-executable instructions embodied thereon that, when executed, facilitate a method of providing palliative care to a population of patients. The method includes determining a set of patients that qualify for palliative care; stratifying the set of patients into two or more categories; and prioritizing the patients by predicting at least when specific patients will likely benefit from a palliative care program.

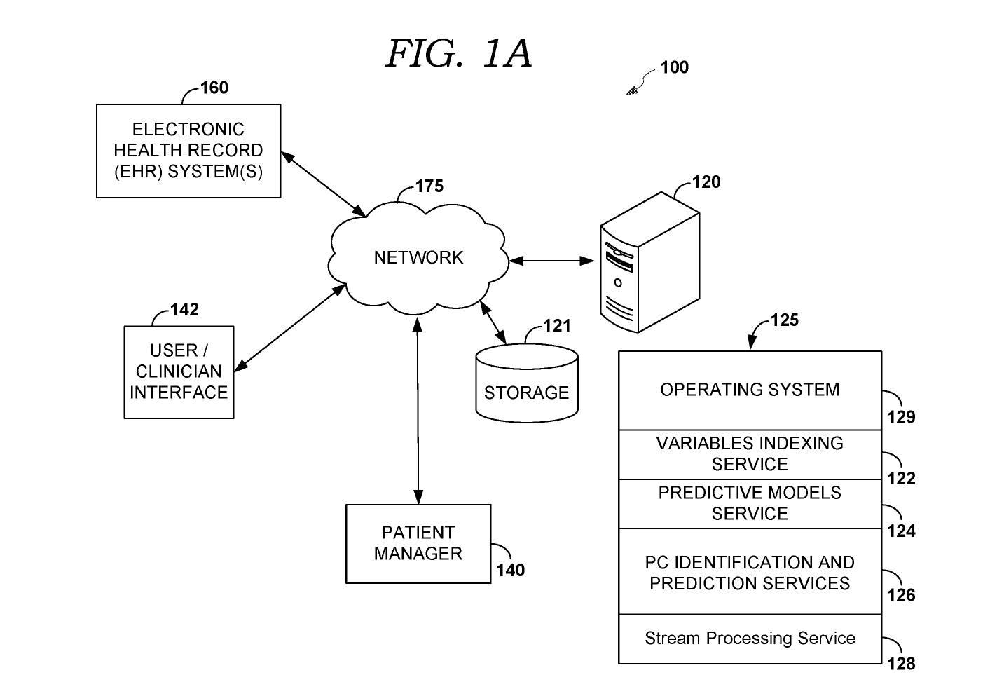

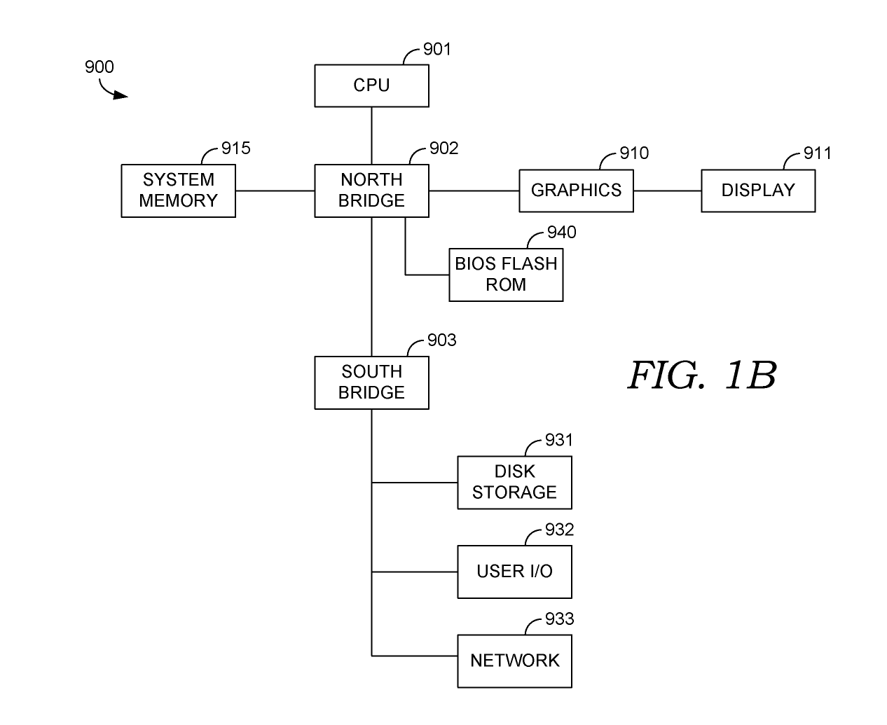

Referring now to the drawings in general, and initially to FIG. 1A in particular, an aspect of an operating environment 100 is provided suitable for practicing an embodiment of our invention. We show certain items in block-diagram form more for being able to reference something consistent with the nature of a patent than to imply that a certain component is or is not part of a certain device. Similarly, although some items are depicted in the singular form, plural items are contemplated as well (e.g., what is shown as one data store might really be multiple data-stores distributed across multiple locations). But showing every variation of each item might obscure the invention. Thus for readability, we show and reference items in the singular (while fully contemplating, where applicable, the plural).

As shown in FIG. 1, example operating environment 100 provides an aspect of a computerized system for compiling and/or running embodiments of services related to providing PC including, for example, identifying patients likely qualifying for PC, providing PC to a population of patients, and managing palliative care of one or more patient populations, which may also include predicting PC utilization. Environment 100 includes one or more electronic health record (EHR) systems, such as hospital EHR system 160, communicatively coupled to network 175, which is communicatively coupled to computer system 120. In some embodiments, components of environment 100 that are shown as distinct components may be embodied as part of or within other components of environment 100. For example, EHR systems 160 may comprise one or a plurality of EHR systems such as hospital EHR systems, health information exchange EHR systems, ambulatory clinic EHR systems, psychiatry/neurology EHR systems, pharmacy records, hospice records, other patient-care related records, as well as records of patient claims data such as insurance claims. Thus the term EHR is used broadly herein to refer to any sort of electronic health-related records for one or more patients, and further may be implemented in computer system 120. Similarly, EHR system 160 may perform functions for two or more of the EHR systems (not shown).

Network 175 may comprise the Internet, and/or one or more public networks, private networks, other communications networks such as a cellular network, or similar network(s) for facilitating communication among devices connected through the network. In some embodiments, network 175 may be determined based on factors such as the source and destination of the information communicated over network 175, the path between the source and destination, or the nature of the information. For example, intra-organization or internal communication may use a private network or virtual private network (VPN). Moreover, in some embodiments items shown communicatively coupled to network 175 may be directly communicatively coupled to other items shown communicatively coupled to network 175.

In some embodiments, operating environment 100 may include a firewall (not shown) between a first component and network 175. In such embodiments, the firewall may reside on a second component located between the first component and network 175, such as on a server (not shown), or reside on another component within network 175, or may reside on or as part of the first component.

Embodiments of electronic health record (EHR) system 160 include one or more data stores of health records, which may be stored on storage 121, and may further include one or more computers or servers that facilitate the storing and retrieval of the health records. In some embodiments, EHR system 160 may be implemented as a cloud-based platform or may be distributed across multiple physical locations. EHR system 160 may further include record systems, which store real-time or near real-time patient (or user) information, such as wearable, bedside, or in-home patient monitors, for example.

Although FIG. 1A depicts an exemplary EHR system 160, it is contemplated that an embodiment relies on patient manager 140 for storing and retrieving patient record information such as information acquired from one or more patient monitors or sensors (not shown).

Example operating environment 100 further includes provider user/clinician interface 142 communicatively coupled through network 175 to an EHR system 160. Although environment 100 depicts an indirect communicative coupling between interface 142 and EHR system 160 through network 175, it is contemplated that an embodiment of interface 142 is communicatively coupled to EHR system 160 directly. An embodiment of interface 142 takes the form of a user interface operated by a software application or set of applications on a client computing device such as a personal computer, laptop, smartphone, or tablet computing device. In an embodiment, the application includes the PowerChart® software manufactured by Cerner Corporation. In an embodiment, the application is a Web-based application or applet. A provider clinician application facilitates accessing and receiving information from a user or health care provider about a specific patient or set of patients for which the likelihood(s) of future events such as acute risk of deterioration are determined according to the embodiments presented herein. Embodiments of interface 142 also facilitates accessing and receiving information from a user or health care provider about a specific patient or population of patients including patient history; health care resource data; variables measurements, time series, and predictions (including plotting or displaying the determined outcome and/or issuing an alert) described herein; or other health-related information, and facilitates the display of results, recommendations, or orders, for example. In an embodiment, interface 142 also facilitates receiving orders for the patient from the clinician/user, based on the results of monitoring and predictions. Interface 142 may also be used for providing diagnostic services or evaluation of the performance of various embodiments.

An embodiment of patient manager 140 takes the form of a user interface and application, which may be embodied as a software application operating on one or more mobile computing devices, tablets, smartphones, front-end terminals in communication with back-end computing systems, laptops, or other computing devices. In an embodiment, manager 140 includes a Web-based application or set of applications usable to manage user services provided by an embodiment of the invention. For example, in an embodiment, manager 140 facilitates processing, interpreting, accessing, storing, retrieving, and communicating information acquired from one or more patient monitors, sensors, or other sources of patient information. In an embodiment, manager 140 sends an alarm indication directly to user/clinician interface 142 through network 175. In an embodiment, manager 140 sends a maintenance indication to provider clinician interface 142. In one embodiment of manager 140, an interface component may be used to facilitate access by a user (including a clinician/caregiver or patient) to functions or information on patient monitors or sensors, such as operational settings or parameters, user identification, user data stored on the monitors or sensors, and diagnostic services or firmware updates, for example.

In some embodiments, example operating environment may further include one or more patient monitors (not shown), sometimes referred to herein as an patient-interface component), which may comprise one or more sensor components operable to acquire clinical or physiological information about a patient, such as various types of physiological measurements, physiological variables, or similar clinical information associated with a particular physical or mental state of the patient, and which may be acquired periodically or as one or more time series. In an embodiment, the patient monitor may comprise a patient bedside monitor, such used in hospital. In an embodiment, one or more sensor components of the monitor may comprise a user-wearable sensor component or sensor component integrated into the patient's environment. Examples of sensor components of a patient monitor include a sensor positioned on an appendage (on or near the user's head, attached to the user's clothing, worn around the user's head, neck, leg, arm, wrist, ankle, finger, etc.); skin-patch sensor; ingestible or sub-dermal sensor; sensor component(s) integrated into the user's living environment (including the bed, pillow, or bathroom); and sensors operable with or through a smartphone carried by the user, for example. It is also contemplated that the clinical or physiological information about patient, such as the monitored variables, used according to the embodiment of the invention disclosed herein may be received from human measurements or automatically determined by sensors in proximity to the patient. For example, in one embodiment, a nurse periodically measures a patients' blood pressure and enters the measurement via manager 140 or interface 142.

Examples of physiological variables monitored by patient monitors can include, by way of example and not limitation, heart rate, blood pressure, oxygen saturation (SoO2), central venous pressure, other vital signs or any type of measureable or determinable physiological or clinical variable associated with a patient, which may be used for forecasting a future value (of the measured variable, a composite variable based on one or more measured variables, or other factor determined at least in part from one or more measured variables) of a patient in order to facilitate clinical decision making. For example, in some embodiments, a monitor may be used for acquiring other types physiological variables such as, muscle activity which might be sensed from electromyogram signals, eye movement which might be sensed from electro-oculogram signals, or other biometric information. In an embodiment, a monitor comprises a sensor probe, such as an EEG probe, and a communication link that periodically transmits identification information and probe data to patient manager 140, so that the time series of monitored values is stored on patient manager 140, enabling the patient manager to form a raw binary alarm indication and/or a physiological variable decision statistic. In an embodiment, a patient monitor collects raw sensor information, such as an optical sensor, and performs signal processing, such as movement detection, kinematic modeling, distance and shape processing, velocity measurement, forming a physiological variable decision statistic, cumulative summing, trending, wavelet processing, thresholding, computational processing of decision statistics, logical processing of decision statistics, pre-processing or signal condition, etc., part or all of which may be performed on the monitor, manager 140, interface 142, and/or computer system 120.

An embodiment of a patient monitor stores user-derived data locally or communicates data over network 175 to be stored remotely. In an embodiment, manager 140 is wirelessly communicatively coupled to the monitor. Patient manager 140 may also be embodied as a software application or app operating on a user's mobile device. In an embodiment, manager 140 and a patient monitor are functional components of the same device, such as a device comprising a sensor and a user interface. In an embodiment, manager 140 is embodied as a base station, which may also include functionality for charging a patient monitor or downloading information from the monitor.

Example operating environment 100 further includes computer system 120, which may take the form of a server, which is communicatively coupled through network 175 to EHR system 160, and storage 121.

Computer system 120 comprises one or more processors operable to receive instructions and process them accordingly, and may be embodied as a single computing device or multiple computing devices communicatively coupled to each other. In one embodiment, processing actions performed by system 120 are distributed among multiple locations such as one or more local clients and one or more remote servers, and may be distributed across the other components of example operating environment 100. For example, a portion of computing system 120 may be embodied on one or more patient monitors or manager 140 for performing signal conditioning of the measured patient variable(s). In one embodiment, system 120 comprises one or more computing devices, such as a server, desktop computer, laptop, or tablet, cloud-computing device or distributed computing architecture, a portable computing device such as a laptop, tablet, ultra-mobile P.C., or a mobile phone.

Embodiments of computer system 120 include computer software stack 125, which in some embodiments operates in the cloud, as a distributed system on a virtualization layer within computer system 120, and includes operating system 129. Operating system 129 may be implemented as a platform in the cloud, and which is capable of hosting a number of services such as 122, 124, 126, and 128. Some embodiments of operating system 129 comprise a distributed adaptive agent operating system. Embodiments of services 122, 124, 126, and 128 run as a local or distributed stack in the cloud, on one or more personal computers or servers such as system 120, and/or a computing device running interfaces 140 and 142. In some embodiments, interface 142 operates in conjunction with software stack 125.

In embodiments, variables indexing (or mapping) service 122 provide services that facilitate retrieving frequent item sets, extracting database records, and cleaning the values of variables in records. For example, service 122 may perform functions for synonymic discovery, indexing or mapping variables in records, or mapping disparate health systems' ontologies, such as determining that a particular medication frequency of a first record system is the same as another record system. In some embodiments, these services may invoke one or more computation services within services 124 and/or 126. In one embodiment software stack 125 includes PC models service 124, which comprises the services or routines for providing and managing PC, which may include forecasting values of one physiological variable(s).

PC identification and prediction services 126 include the PC algorithms described herein for identifying patients likely qualifying for PC, providing PC to a population of one or more patients (including generating worklists, condition modules, situation modules, providing patient portal services), and managing populations of patients including PC prediction services. Embodiments of services 126 may comprise one or more computer routines, programs, applications, or software agents. Further, some embodiments of services 124 and 126 may perform statistical software operations, and include statistical calculation packages such as, in one embodiment, the R system (the R-project for Statistical Computing, which supports R-packages or modules tailored for specific statistical operations, and which is accessible through the Comprehensive R Archive Network (CRAN) at http://cran.r-project.org). Some embodiments of services 126 comprise a transformation component or service for transforming the physiological or clinical patient information into forecasted value, and a combination component or service for combining successive forecasts into single value. Embodiments of computation services 126 may use one or more services stream processing service(s) 128.

Stream processing service(s) 128 may be embodied using IBM InfoSphere stream processing platform, Twitter Storm stream processing, or similar complex event processing (CEP) platforms, frameworks, or services, which may include the user of multiple such stream processing services (in parallel, serially, or operating independently). In some embodiments service(s) 128 include the Apache Hadoop and Hbase framework, or similar frameworks operable for providing a distributed file system, and which in some embodiments facilitate or provide access to cloud-based services such as those provided by Cerner Healthe Intent®. In one embodiment, stream processing services 128 listens to at least one “channel” of patient information, which may be provided by a patient monitor or other source of patient data, as patient data or processed information becomes available. Some embodiments of the invention also may be used in conjunction with Cerner Millennium®, Cerner CareAware® (including CareAware iBus®), Cerner CareCompass®, or similar products and services.

Example operating environment 100 also includes storage 121 (or data store 121), which in some embodiments includes patient data for a candidate or target patient (or information for multiple patients), including raw and processed patient data; variables associated with patient recommendations; recommendation knowledge base; recommendation rules; recommendations; recommendation update statistics; an operational data store, which stores events, frequent itemsets (such as “X often happens with Y”, for example), and item sets index information; association rulebases; agent libraries, solvers and solver libraries, and other similar information including data and computer-usable instructions; patient-derived data; and health care provider information, for example. It is contemplated that the term data includes any information that can be stored in a computer-storage device or system, such as user-derived data, computer usable instructions, software applications, or other information. In some embodiments, data store 121 comprises the data store(s) associated with EHR system 160. Further, although depicted as a single storage data store, data store 121 may comprise one or more data stores, or may be in the cloud.

Turning briefly to FIG. 1B, there is shown one example embodiment of computing system 900 that has software instructions for storage of data and programs in computer-readable media. Computing system 900 is representative of a system architecture that is suitable for computer systems such as computing system 120. One or more CPUs such as 901, have internal memory for storage and couple to the north bridge device 902, allowing CPU 901 to store instructions and data elements in system memory 915, or memory associated with graphics card 910, which is coupled to display 911. Bios flash ROM 940 couples to north bridge device 902. South bridge device 903 connects to north Bridge device 902 allowing CPU 901 to store instructions and data elements in disk storage 931 such as a fixed disk or USB disk, or to make use of network 933 for remote storage. User I/O device 932 such as a communication device, a mouse, a touch screen, a joystick, a touch stick, a trackball, or keyboard, couples to CPU 901 through south bridge 903 as well. The system architecture depicted in FIG. 1B is provided as one example of any number of suitable computer architectures, such as computing architectures that support local, distributed, or cloud-based software platforms, and are suitable for supporting computing system 120.

Returning to FIG. 1A, in some embodiments, computer system 120 is a computing system made up of one or more computing devices. In some embodiments, computer system 120 includes one or more software agents, and in an embodiment includes an adaptive multi-agent operating system, but it will be appreciated that computer system 120 may also take the form of an adaptive single agent system or a non-agent system. Computer system 120 may be a distributed computing system, a data processing system, a centralized computing system, a single computer such as a desktop or laptop computer or a networked computing system.

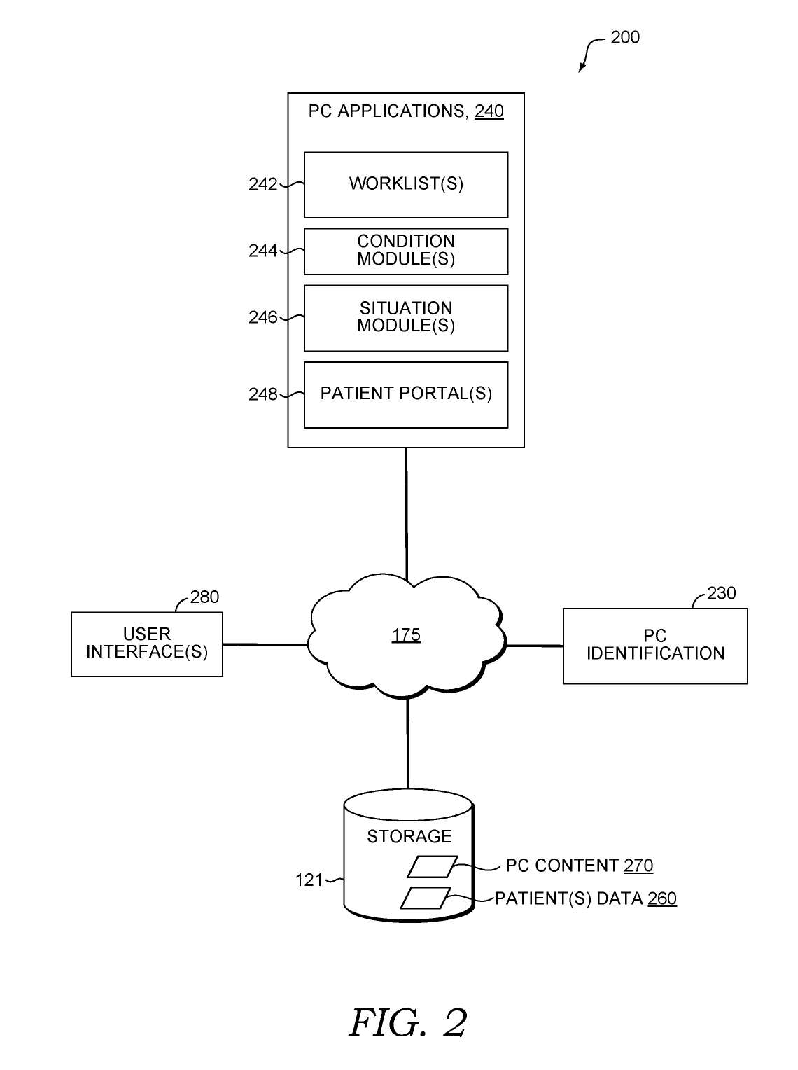

Referring now to FIG. 2, with FIG. 1A, a block diagram is provided showing aspects of an example computing system architecture suitable for implementing an embodiment of the invention and designated generally as system 200. System 200 represents only one example of a suitable computing-system architecture. Other arrangements and elements can be used in addition to or instead of those shown, and some elements may be omitted altogether for the sake of clarity. Further, as with operating environment 100, many of the elements described herein are functional entities that may be implemented as discrete or distributed components or in conjunction with other components, and in any suitable combination and location.

Example system 200 includes network 175, which is described in connection to FIG. 1A, and which communicatively couples components of system 200 including PC applications 240 (including its components 242, 244, 246, and 248), user interface(s) 280, PC identification 230, and storage 121. The components of example system 200 may be embodied as a set of compiled computer instructions or functions, program modules, computer software services, or an arrangement of processes carried out on one or more computer systems, such as computing system 120 described in connection to FIG. 1A, for example.

In one embodiment, the functions performed by components of system 200 are associated with one or more PC-related, services or routines. In particular, such applications, services or routines may operate on or distributed across one or more user devices (such as smart phones, mobile devices, tabled computers, personal computers, patient monitors, for example), servers, or other computing devices (such as computing system 120), or be implemented in the cloud. Moreover, functions performed by these components, or services carried out by these components may be implemented at appropriate abstraction layer(s) such as the operating system layer, application layer, hardware layer, etc., of the computing system(s). Alternatively, or in addition, the functionality of these components and/or the embodiments of the invention described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. Additionally, although functionality is described herein with regards to specific components shown in example system 200, it is contemplated that in some embodiments functionality of these components can be shared or distributed across other components.

With continuing reference to system 200 of FIG. 2, at a high level, some embodiments of the invention provide a cross-continuum PC program, which may use cloud supported intelligence in some embodiments, for identifying patients in need of PC services and/or for communicating this information to an appropriate care team. In particular, one embodiment utilizes patient centric information in combination with evidence based logic to provide an accurate and automated alternative to the ‘assuming and guessing’, which is largely done today as many providers are unaware of the qualifications or needs for PC across a population. Additionally, after identifying qualifying patients, some embodiments of the cross-continuum PC program subsequently predict the needs and impact of PC services in a community or population of patients. This may be leveraged at a facility or network level. Further, these embodiments may directly impact provider workflows by enabling providers to be increasingly aware of patients in need of Palliative care. Thus through such embodiments, health care providers can manage and care for their patients in a coordinated and consistent manner that utilizes EMR tools such as Palliative Care specific worklists, plans of care content, real-time and near real-time decision support. In some embodiments, the sequencing and architecture of PC content elements are specific to supporting the PC clinician workflow. As with any successful program, the ability to analyze and measure against performance standards will help to optimize performance and determine where PC is impacting care.

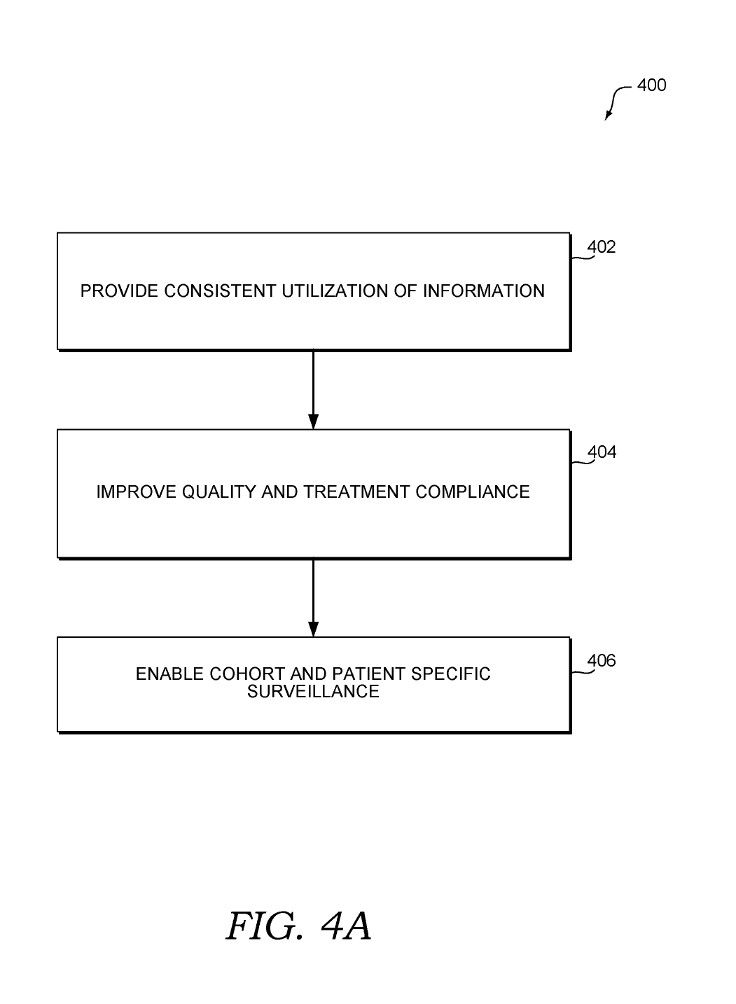

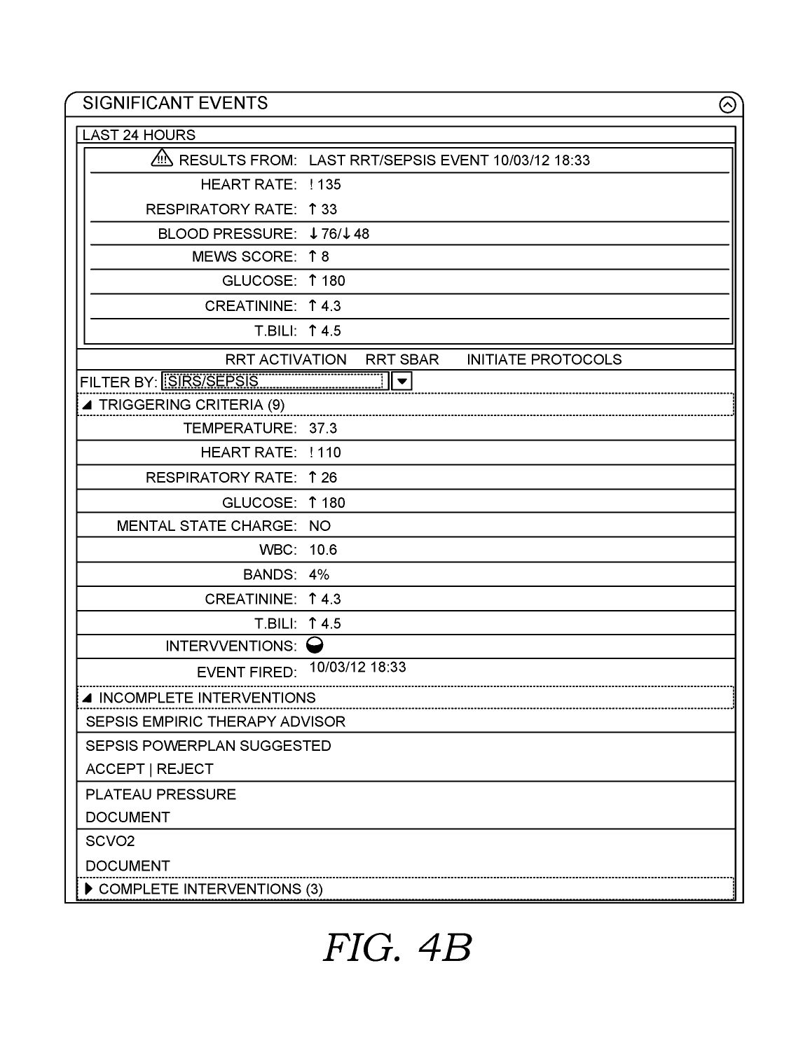

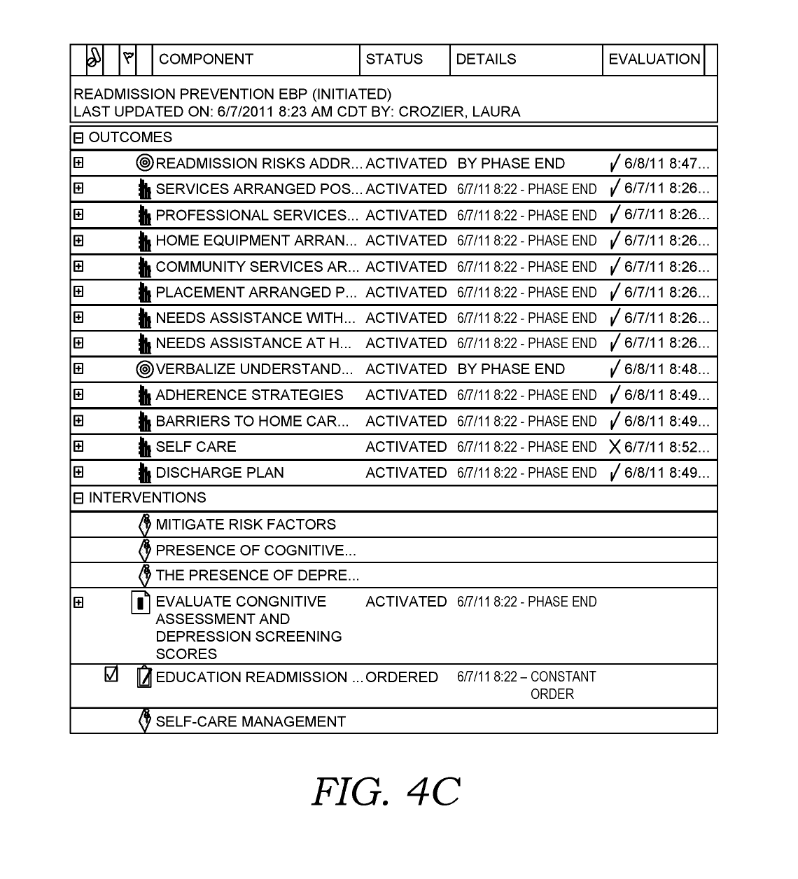

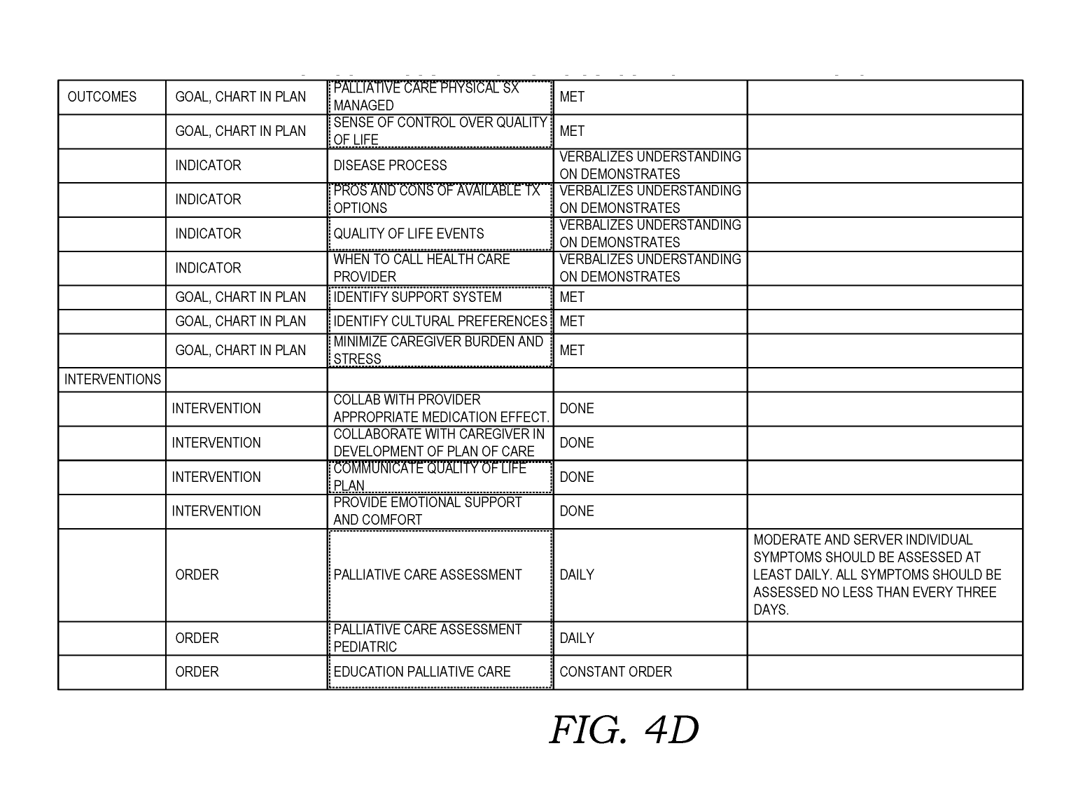

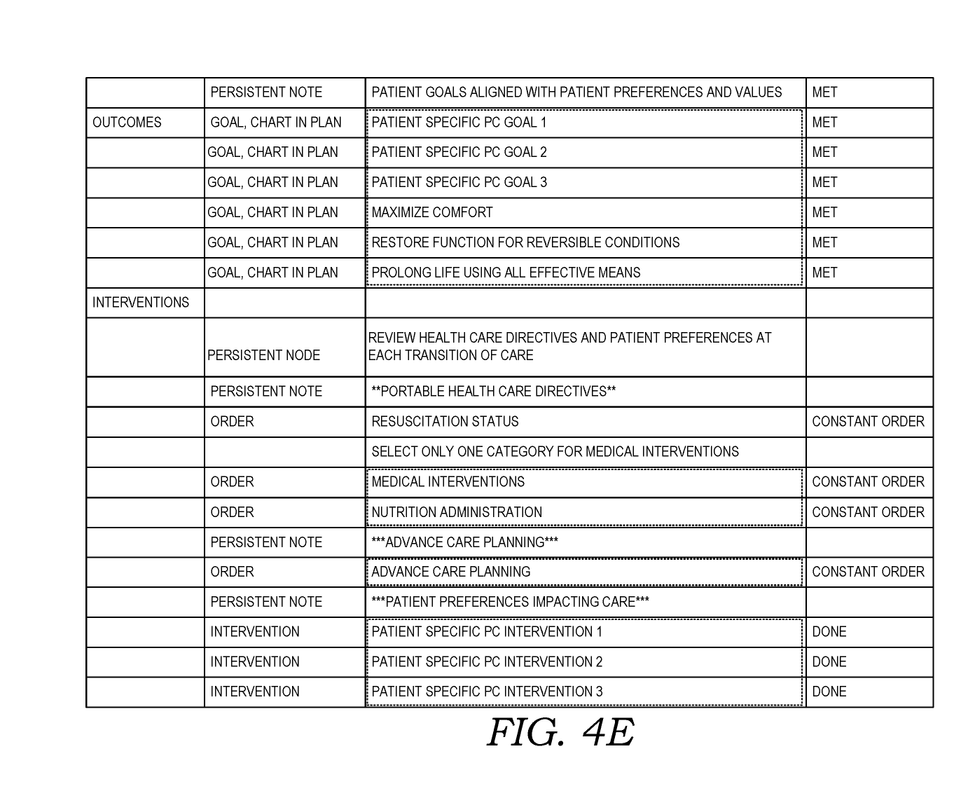

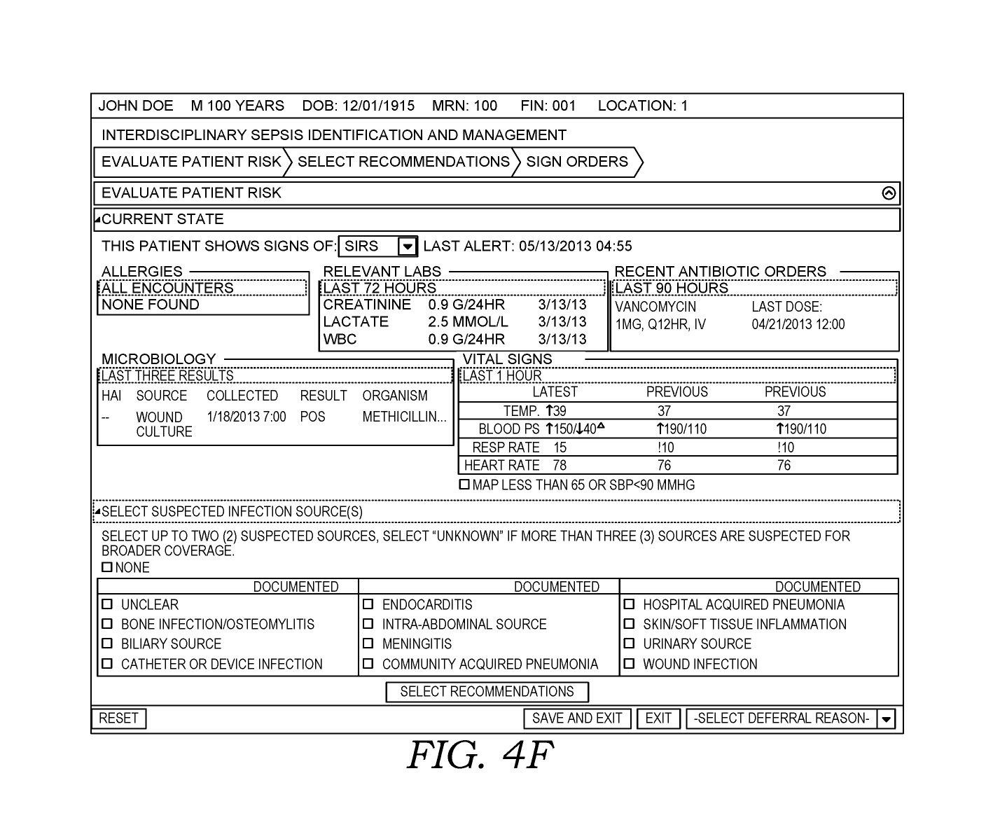

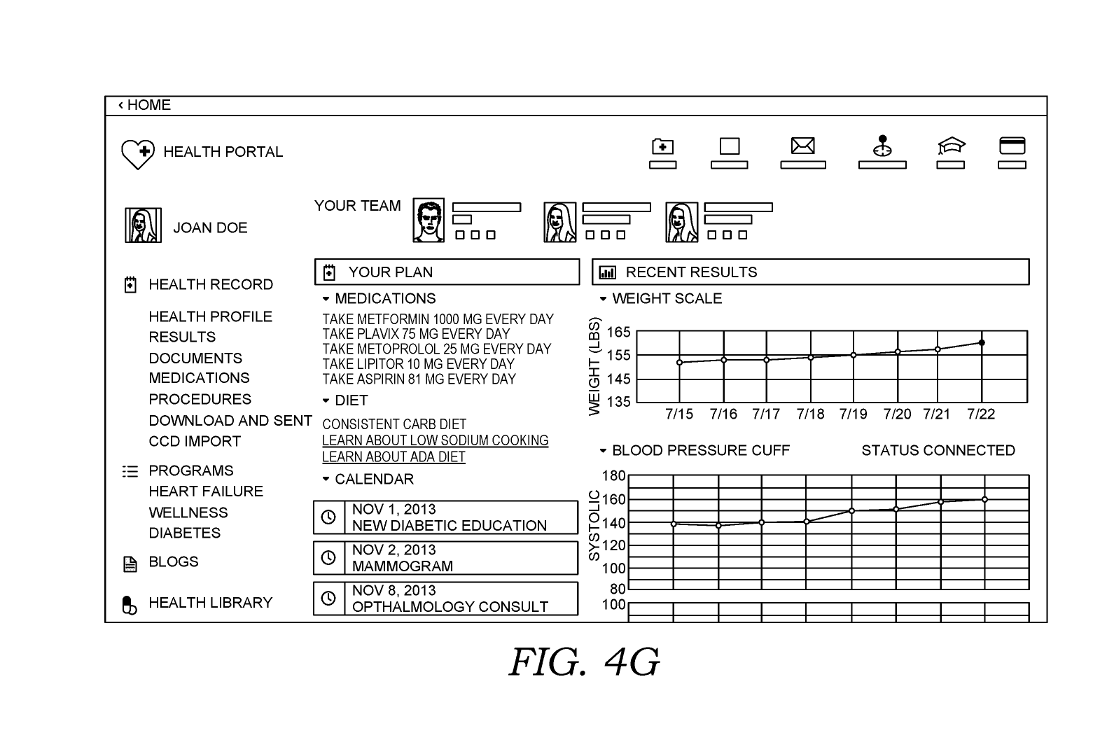

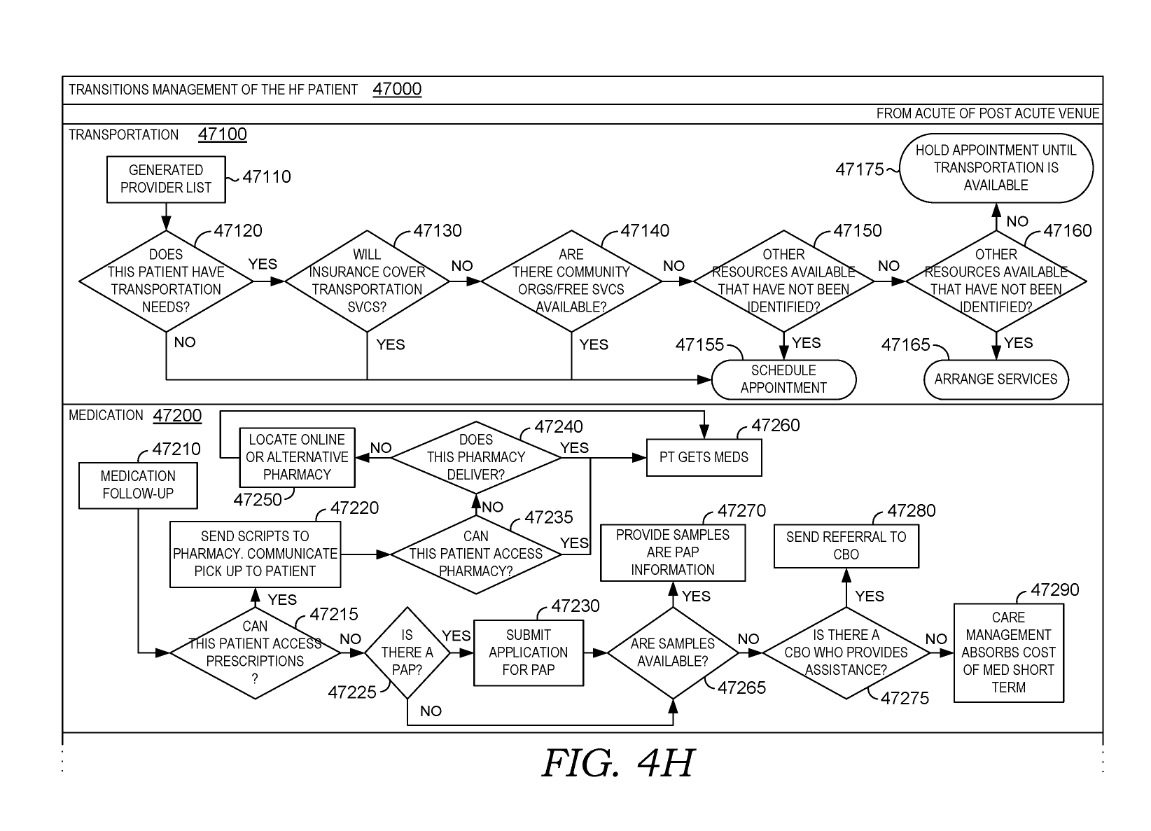

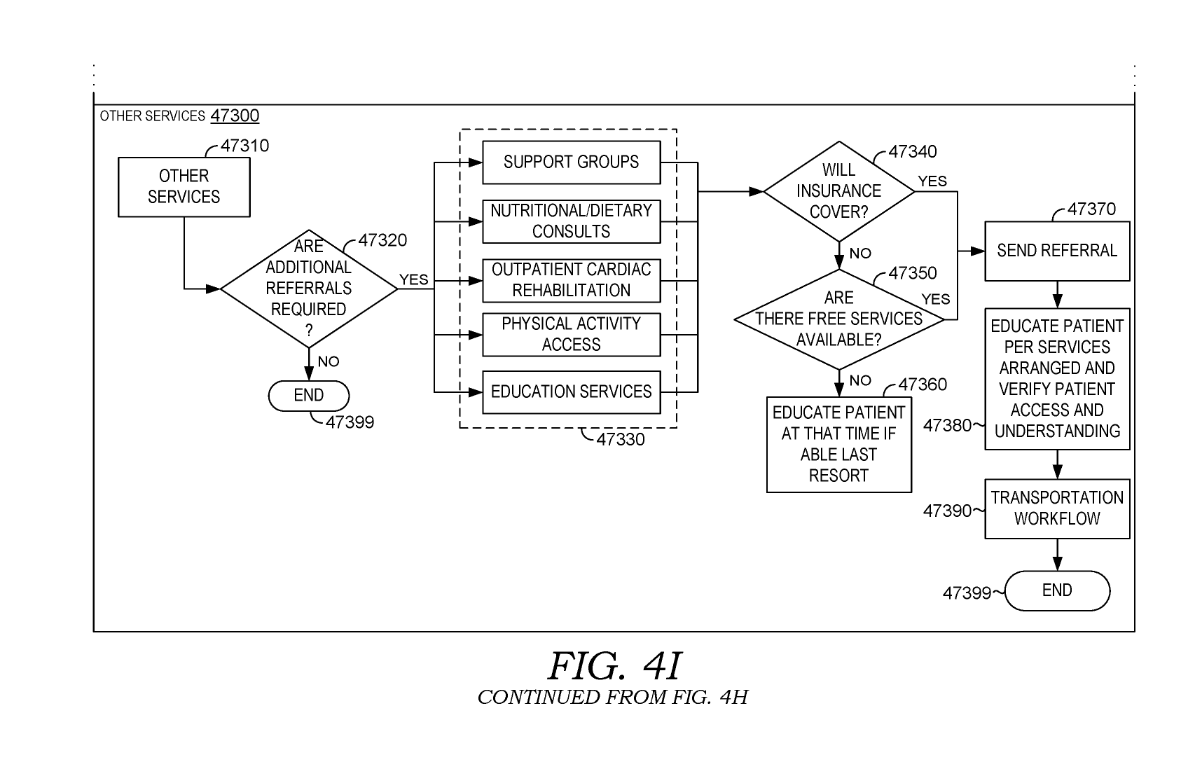

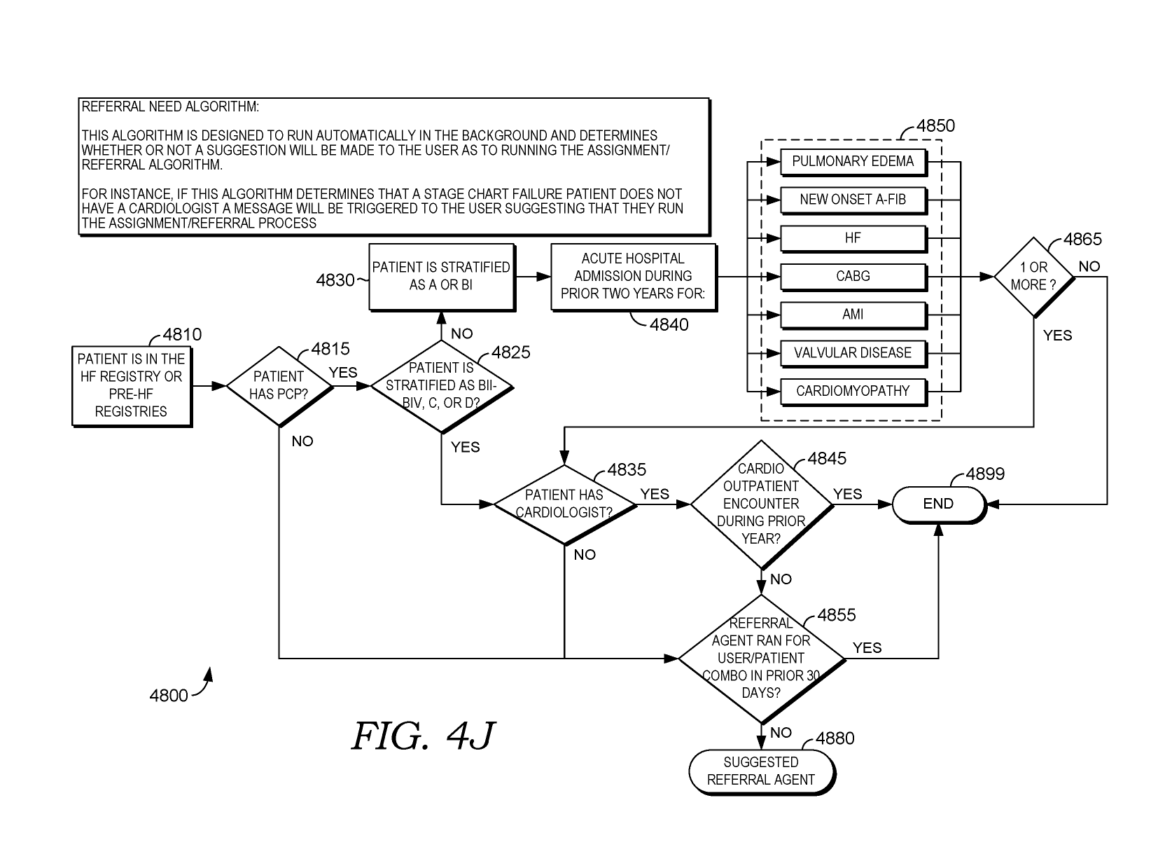

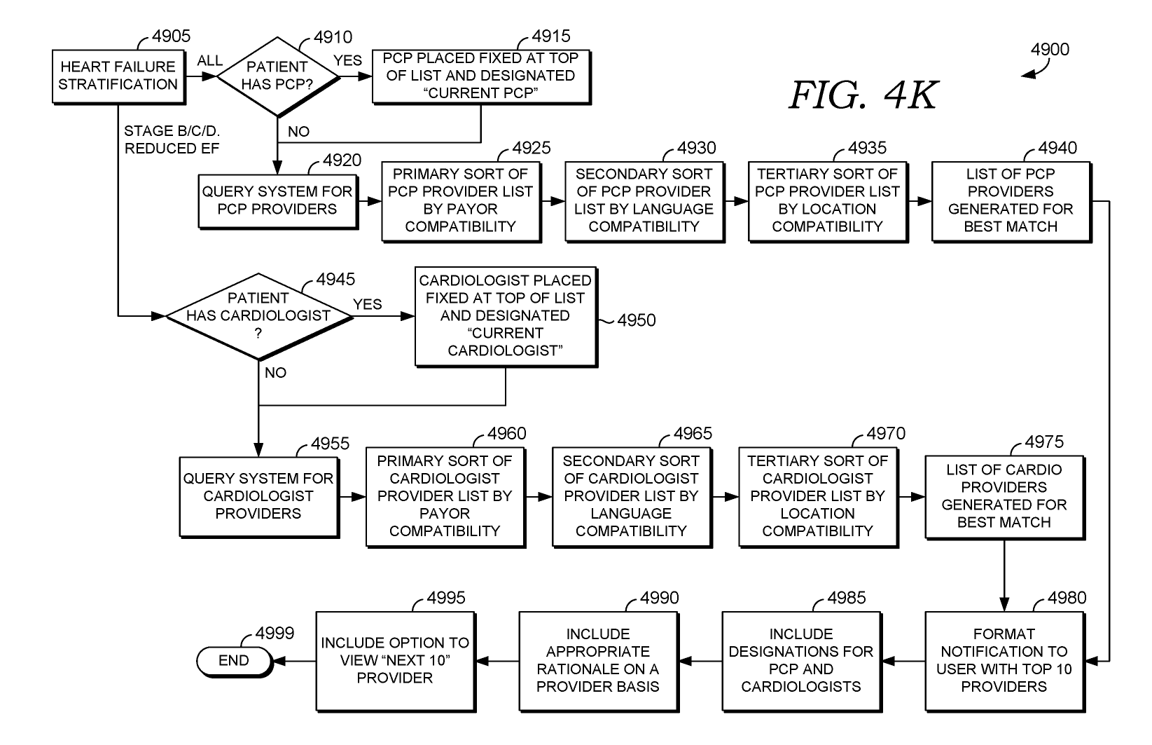

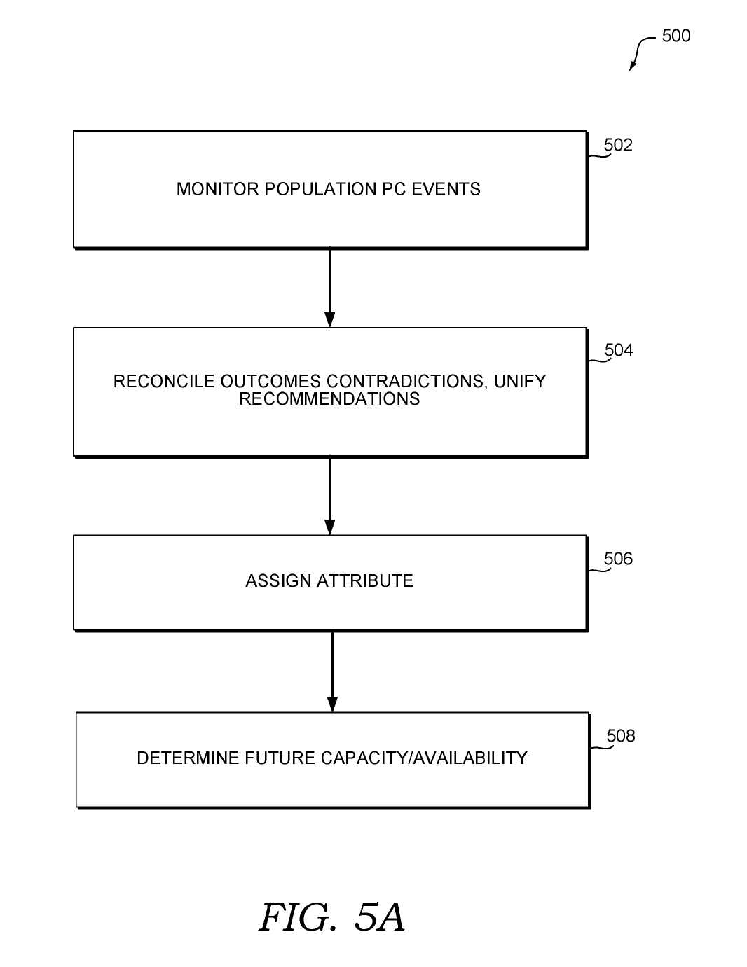

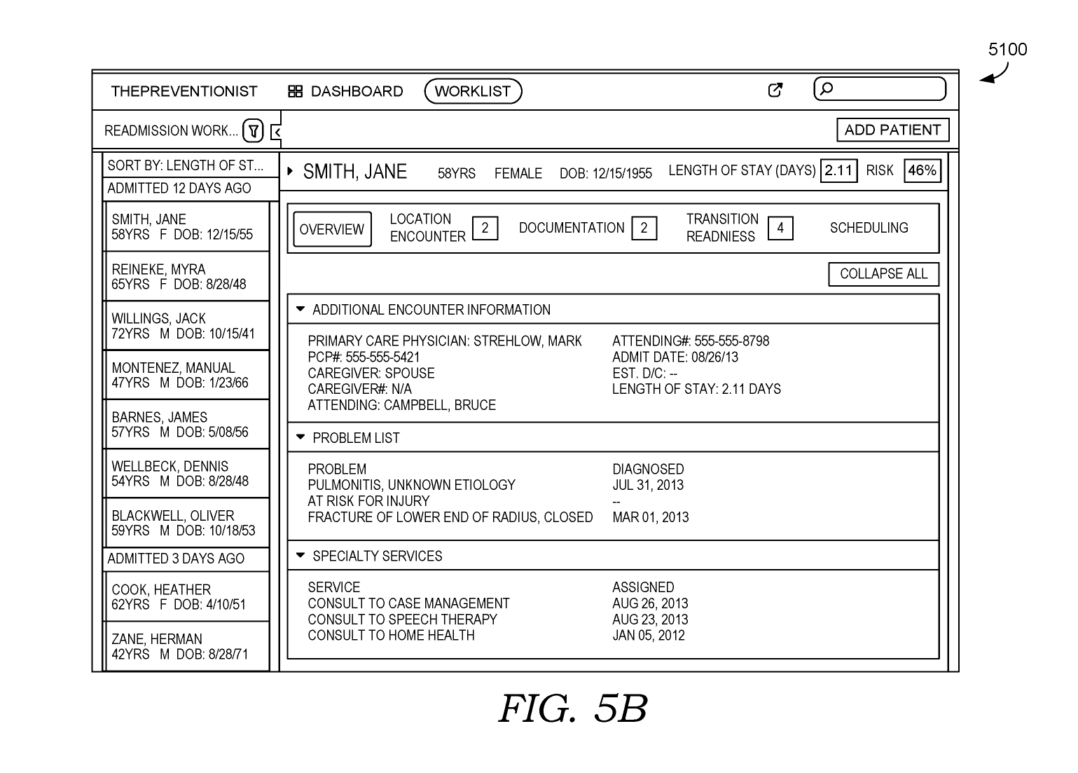

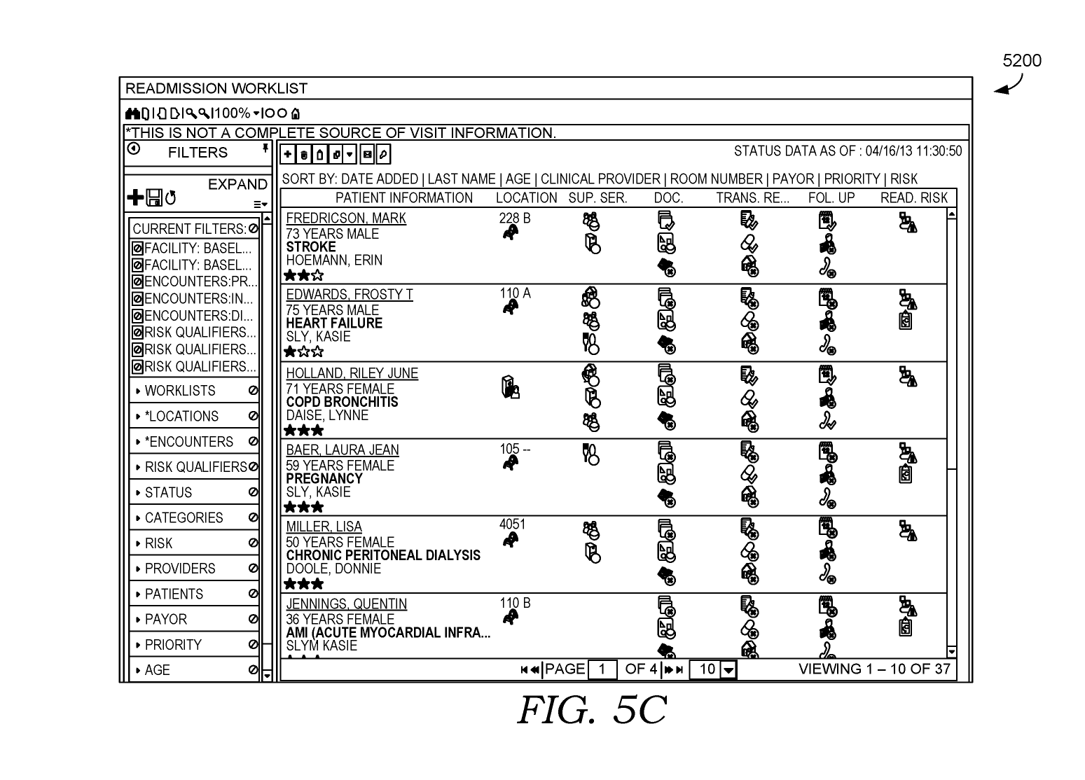

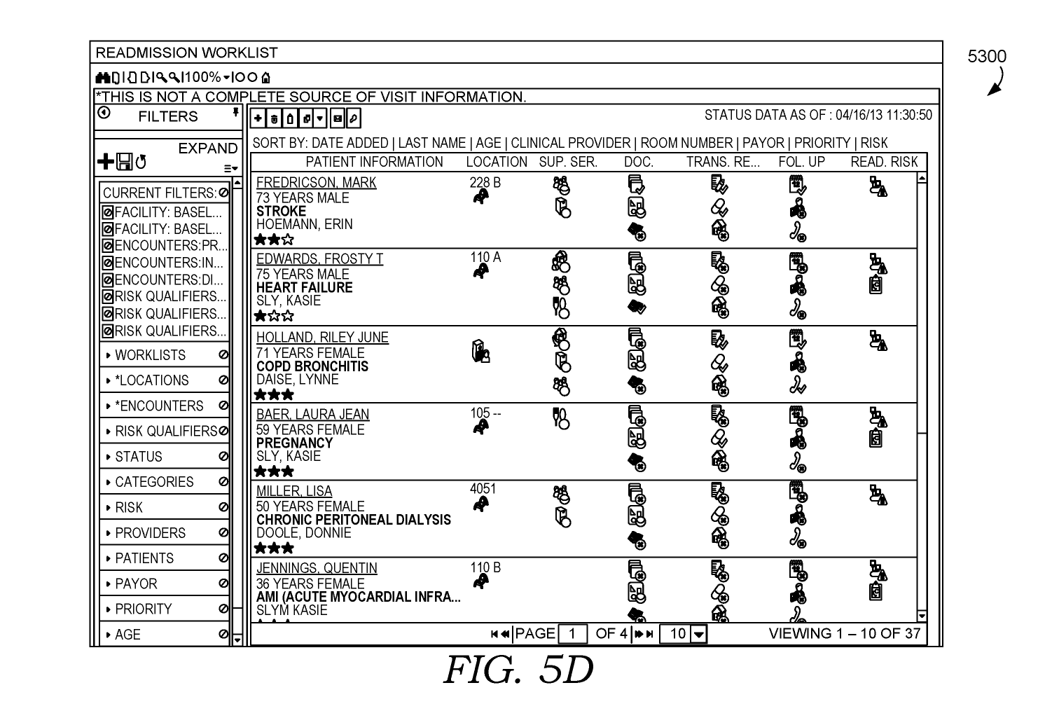

Continuing with system 200 of FIG. 2, user interface(s) 280 is generally responsible for providing user-interfacing functionality to patients and caregivers including receiving input and outputting information such as visual displays, such as PC worklists or audible alerts or alarms. For example, user interface(s) 280 may be used for displaying and receiving input related to a patient's significant events (e.g., FIG. 4B), interdisciplinary plan of care (IPOC) workflows, outcomes and interventions, (e.g. FIGS. 4C-4F), patient portals (e.g., FIG. 4G), or worklists (e.g., FIG. 5B-5D). Some embodiments of user interface(s) 280 comprise patient manager 140 and/or user/clinician interface 142 described in connection to FIG. 1A.

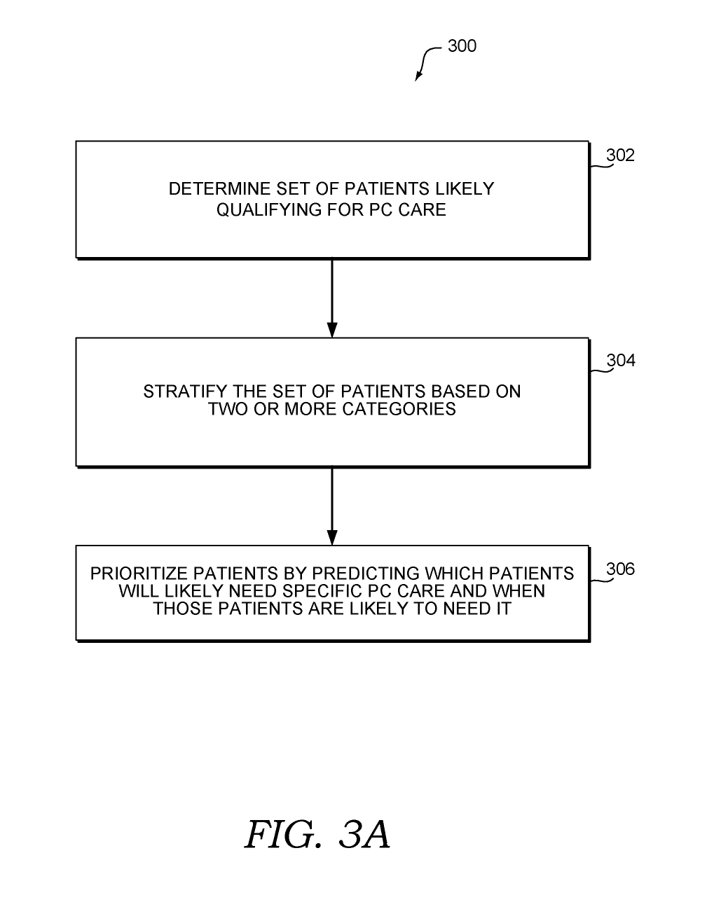

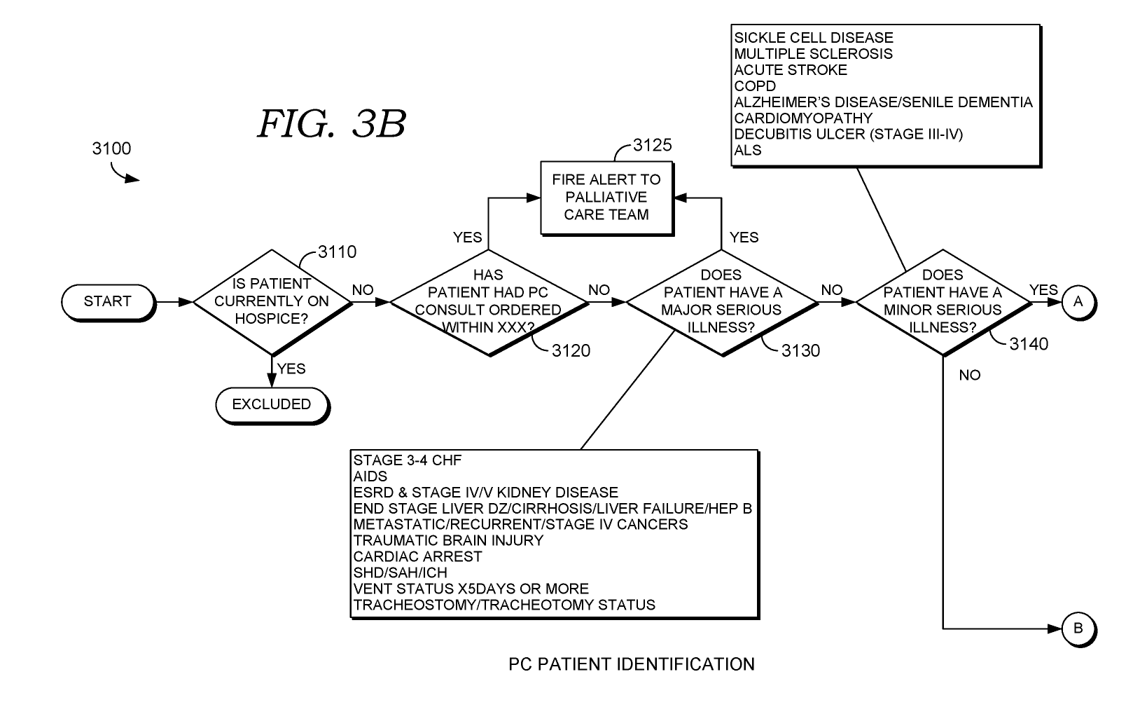

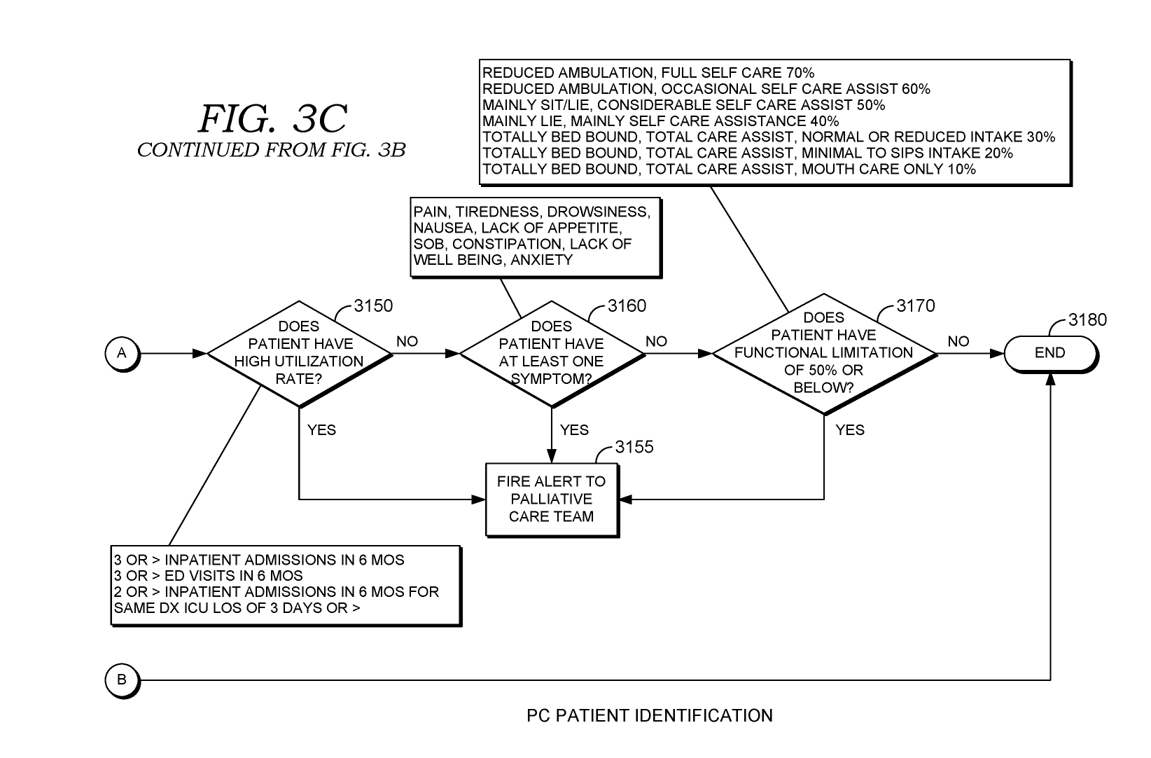

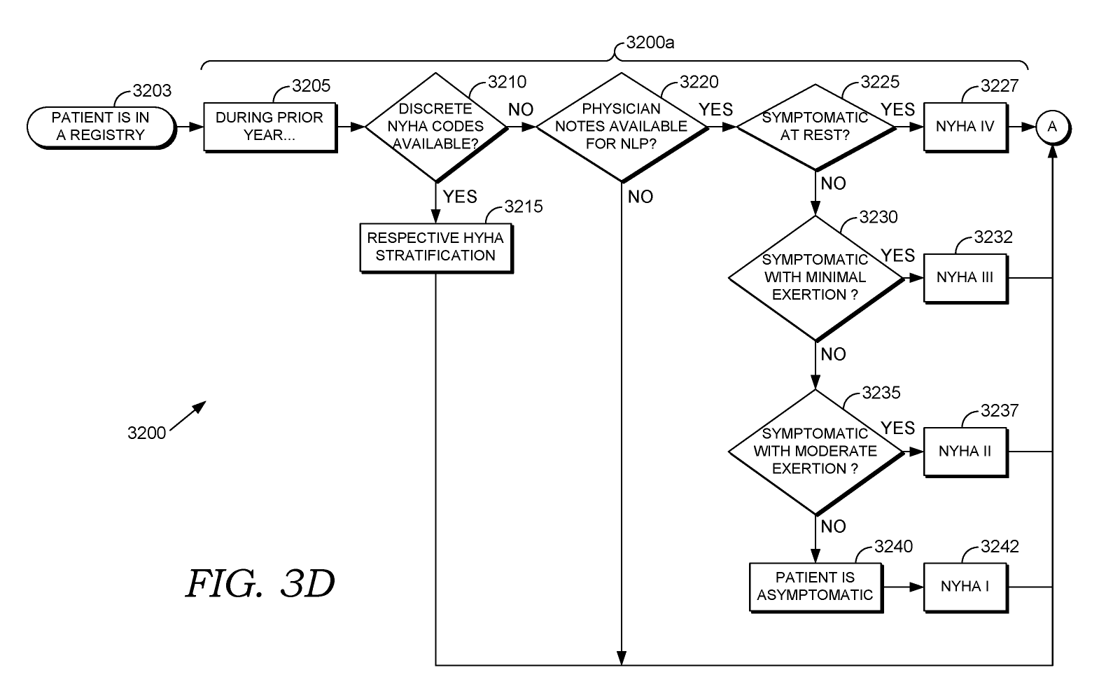

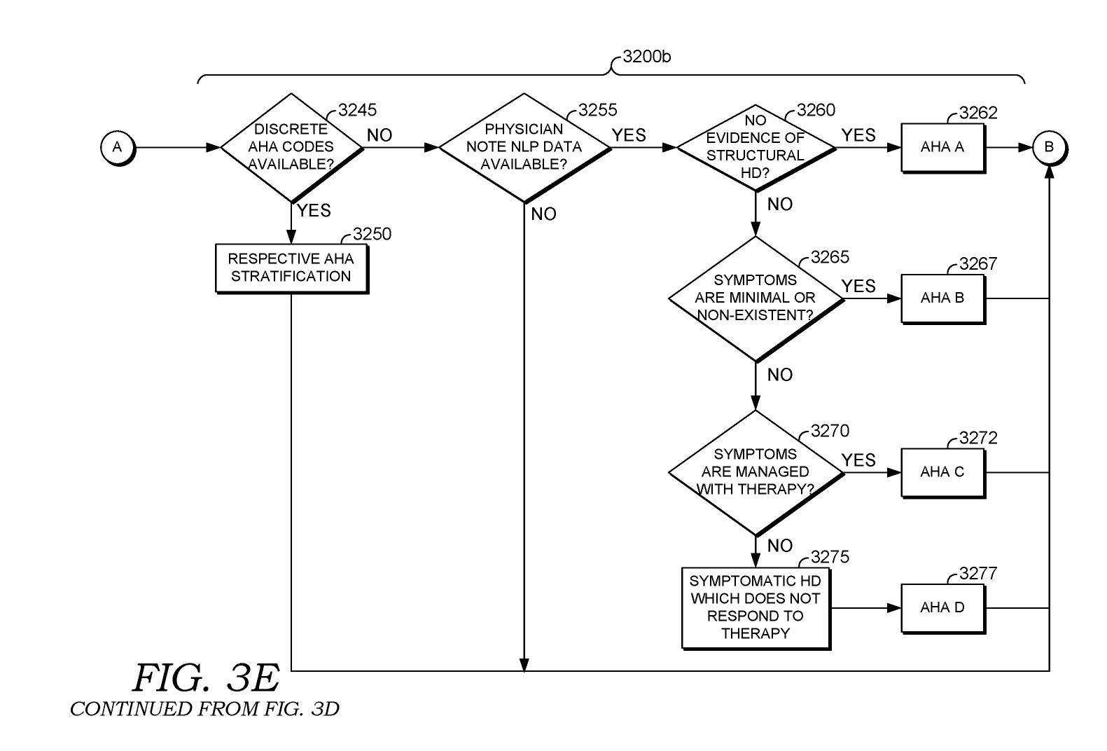

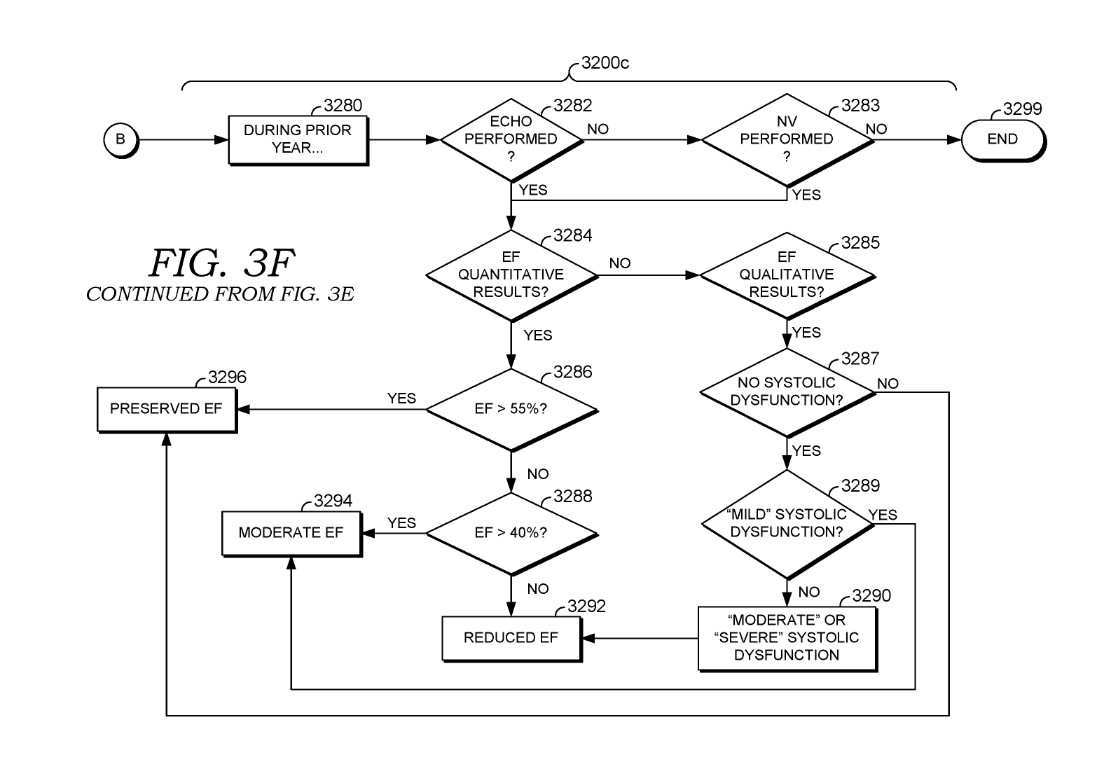

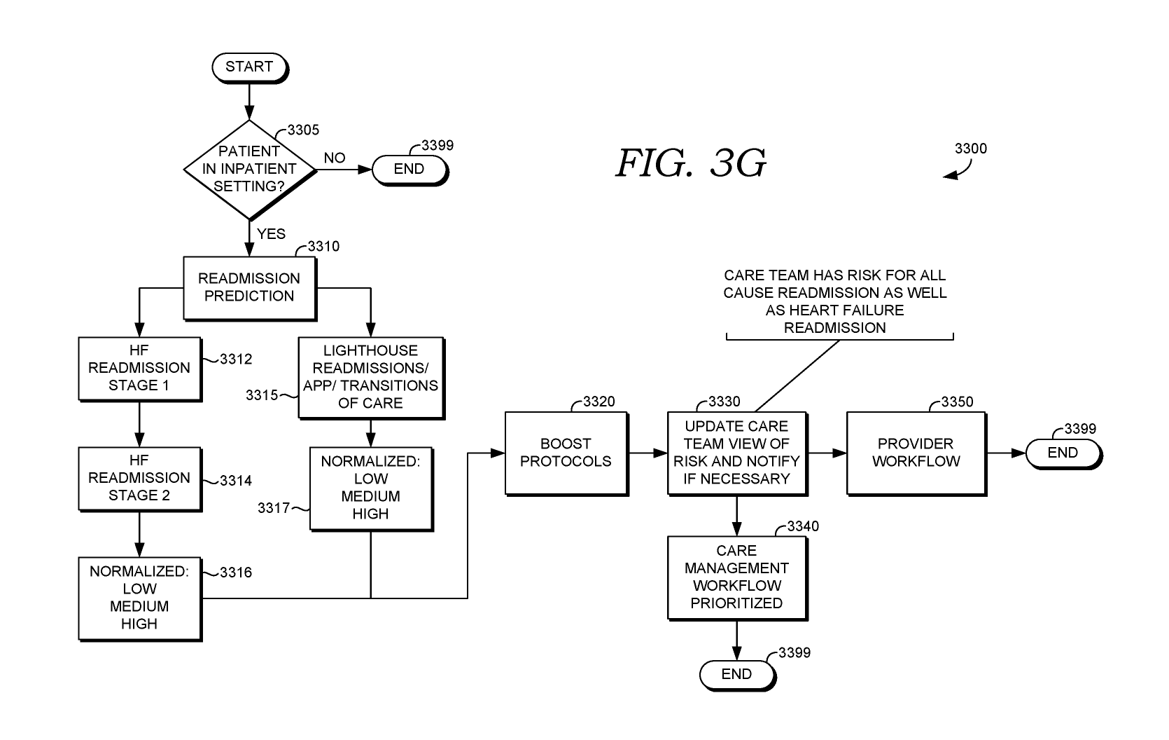

PC Identification component 230 is generally responsible for identifying patients likely qualifying for palliative care. Embodiments of PC identification 230 may comprise evaluating patient(s) data 260 to determine a set of patients that merit consultation with one or more health care providers to confirm whether a PC program is appropriate for each of those patients. In one embodiment, PC identification 230 comprises one or more computer routines or software agents and algorithm(s) for identifying those patients. Additional details of PC identification 230 are provided in connection to FIGS. 3A-3C.

Storage 121 is described in connection to FIG. 1A. As shown in example system 200, storage 121 includes PC content 270 and data from one or more patients (patient(s) data 260. Patient(s) data 260 comprises patient information from one or more EHRs (such as EHR 160), which may also include claims data such as medical claims and pharmacy claims, and other patient information, including information from multiple venues or sources. Patient(s) data 260 may also include PC care pathways and/or PC-related recommendations associated with specific patients.

PC content 270 may comprise any of the following: PC algorithms data, such as one or more PC identification algorithms (described in connection to FIGS. 3B-3C, and carried out by PC identification component 230, in an embodiment); PC stratification algorithms (described in connection to FIGS. 3D-3F, and also carried out by PC identification component 230, in an embodiment); one or more PC prediction models, such as models predicting future need of PC, PC to hospice, ED visit prevention, admission prevention (which includes modifiable risk factors, in an embodiment), PC utilization/readmission, and general compliance (Additional details of prediction models are further described in connection to FIG. 3G.); notification/action information for notification/action agents or routines, including PC MD/Team notification content and/or advanced directive alerts; content for modular components such as registry, condition management and situation awareness; PC care plans and care planning content, such as for acute care, ambulatory care, LTC, HH, or home care, any of which may be used by PC IPOC (described in connect into FIGS. 4C-4E); educational content and documentation, including PC education content, nursing documentation (e.g. PC assessment PF, PC education iView content, and iView documentation, for example); MPages content such as worklist PC population management content and significant events (which may also be stored with patient(s) data 260); and/or metrics and analytics content, such as dashboards, scorecards, regulatory content, and program performance content. Some embodiments of care plan content, included in PC content 270, comprise one or more evidence-based care plans for providing personalized plan around a patient's condition, such as heart failure. Some embodiments of action agents comprise routines or software agents for providing notifications and alerts indicating areas for attention that can lead to an improved quality of care, including cross continuum. Additionally, some embodiments of PC content 270 include PC program related events data such as qualifying events that relate to a particular PC program, and which may be flagged or highlighted in various application views for some embodiments, such as the condition module(s) 244.

PC Applications 240 comprises a set of applications for providing PC services including worklist(s) component 242, condition module(s) 244, situation module(s) 246, and patient portal(s) component 248. Worklist(s) component 242 is generally responsible for generating and updating PC population management worklists, such as the example worklists 5100, 5200, and 5300 shown in FIGS. 5B-5D, respectively. With reference to worklists 5100, 5200, and 5300, and FIG. 2, embodiments of worklists provided via worklist(s) component 242 may comprise a list of one or more patients and corresponding tasks specific to a care manager's workflow, which may be populated by a PC program.

Returning to FIG. 2, condition module(s) 244 is generally responsible for providing application services relating to patient conditions. In an embodiment, condition module(s) 244 provides focused information (including events) that contribute to a patient's PC program specific condition. Situation module(s) 246 is generally responsible for PC application services relating to notifications, alerts, and status. In an embodiment, situation module(s) 246 provides information about significant notifications and alerts that have fired across one of more PC programs, centric to the patient, and which may be provided in a unified location or portion of a graphical user interface (such as user interface(s) 280) for the benefit of a caregiver. Finally, patient portal(s) component 248 is generally responsible for generating and managing patient portals, such as the example patient portal depicted in FIG. 4G. With reference briefly to FIG. 4G and FIG. 2, embodiments of patient portals provide patients access to information regarding their PC-qualifying conditions and their PC program generally. In particular, embodiments of patient portals may allow a patient to view PC program events, interact with their own care plans, and access goals and measures.

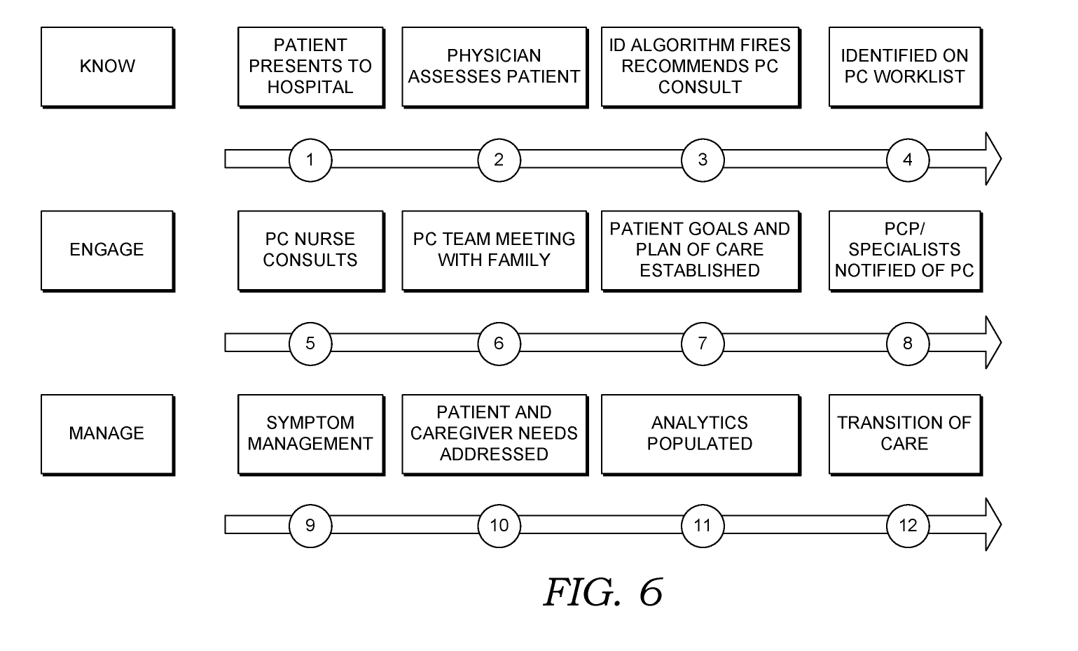

Turning now to FIG. 6, an example PC workflow in an acute setting is provided. The example PC workflow provides an illustrative overview of various aspects of PC described in connection to FIGS. 3A-5C. The example workflow in FIG. 6 comprises 12 steps including: (1) patient presents to hospital; (2) physician assesses the patient; (3) a PC identification algorithm (such as method 3100) is utilized to determine whether the patient should receive a PC consultation; (4) the patient is identified on a PC worklist (example worklists are described in connection to FIGS. 5B-5D); (5) PC nurse consults; (6) PC team meeting with family; (7) patient goals and plan of care established; (8) PCP specialists notified of PC; (9) symptom management is implemented; (10) patient and caregiver needs are assessed and addressed; (11) analytics are determined; and (12) transition of care is carried out.

Turning now to FIGS. 3A-3G, a series of flow charts and drawing are provided relating to PC identification among patients. At a high level, of the methods described in connection to FIGS. 3A-3G may be used to identify patients that would benefit from a palliative care consult and enable the best individual care while managing the palliative care population. In particular, some of these embodiments facilitate identifying (e.g. method 3100 of FIGS. 3B-3C), stratifying (e.g. method 3200 of FIGS. 3D-F), and prioritizing (e.g. method 3300 of FIG. 3G) patients potentially in need of PC. Some embodiments of these methods may be used agnostic of EMR and may further include measuring and/or analyzing outcomes for regulatory requirements and performance improvements goals, with the goal of improving accuracy, efficiency, and operations. Further, some embodiments provide an integrated feedback loop for particular PC programs, including integration/reconciliation with concomitant programs.

With reference to FIG. 3A, a flow diagram is provided illustrating aspects of a method 300 for identifying and prioritizing patients who potentially qualify for PC. At step 302, a set of patients is determined who likely qualify for PC care. In embodiments of step 302, the set of patients may be determined out of a population of patients, based on patient(s) data 260. Further, embodiments of step 302 may also consider demographics, language, and/or consumer of potentially qualifying patients; features and capabilities of PC providers, such as transaction systems and primary language(s); and patient population features such as available community resources. Additional details of step 302 are provided in connection to method 3100 of FIGS. 3B-3C.

At step 304, the set of patients determined in step 302 is stratified or subdivided into categories or divisions. Embodiments of step 304 may stratify patients based on differences in the patients such as diagnoses, conditions or by serious illness/disease profile, utilization and/or spend, for example. Further, when determining subdivisions of PC patients, embodiments of step 304 may also consider previous PC received by the patients, patient socioeconomic class, patient compliance or likelihood of/expected compliance, and patient utilization; provider features, such as group type, provider availability, credentials and procedural foci, and compliance; and patient population criteria such as cost effectiveness. Additional details of step 304 are provided in connection to method 3200 of FIGS. 3D-3F.

At step 306, patients may be prioritized by predicting those patients likely to need specific PC care and forecasting when those patients are likely to need the care. In particular, some embodiments of step 306 apply risk assessment logic to determine one of more of the following: regarding specific patients, some embodiments of step 306 may predict a future spend/cost, admission prevention, utilization/readmission, and compliance; for providers, some embodiments of step 306 may predict attrition, future spend/cost, and resource availability; and for the population of patient, some embodiments of step 306 may predict mortality/morbidity and future resource needs. Additional details of step 304 are provided in connection to method 3300 of FIG. 3G.

Turning now to FIGS. 3B-3D, a flow diagram illustrating a method 3100 for identifying patients likely qualifying for a PC program. In some embodiments, method 3100 provides early or near-real-time identification of qualifying patients, out of a population, that would benefit from a PC consult with a care provider. At a high level, method 3100 identifies target patients such as those having serious illness (which may be determined from diagnoses codes), prior PC consult(s), high hospitalization utilization, specific signs or symptoms, or functional limitations; and also identifies potential risk factors. Some embodiments of method 3100 receive patient(s) data 260. Moreover, method 3100 may include screening for previous PC consults within a defined timeframe or with specific providers. In an embodiment, qualifying for a PC program is based primarily on patient diagnosis and secondary triggers such as hospital utilization rate, symptoms and functional limitation(s) that are in addition to the serious/life-threatening illness). Some embodiments of method 3100 may also identify exclusions, such as hospice patents. Once patients are identified, in some embodiments of the invention, a PC team may be alerted, one or more PC worklists or registries may be generated for the qualifying patient, and a PC pathway for applying stratification of diagnosis may also be created.

Accordingly, method 3100 starts at step 3110, where patient(s) data 260 for a particular candidate patient is received. At step 3110, it is determined whether the candidate patient is on hospice. In this example embodiment, if yes, then the patient is excluded from the set of patients qualifying for PC. If no, then at step 3120, it is determined whether the patient has had a PC consult ordered within a specified timeframe. In some embodiments, a caregiver may be prompted to provide a timeframe, or a timeframe may be determined for specific conditions of the patient (e.g. 1 years for cancer, 3 years for diabetes, 5 years for COPD, or a default value, such as 5 years. If yes, then at step 3125 an alert is provided to a PC team indicating that the patient qualifies for PC. If no, then at step 3130 it is determined whether the candidate patient has a major serious illness. Examples of such illnesses are provided in FIG. 3B, by way of example and not limitation, and include stage 3-4 chf, aids, esrd & stage iv/v kidney disease, end stage liver dz/cirrhosis/liver failure/hep b, metastatic/recurrent/stage iv cancers, traumatic brain injury, cardiac arrest, shd/sah/ich, vent status ×5 days or more, tracheostomy/tracheotomy status. If step 3130 is yes, then method 3100 proceeds to step 3125 and an alert is provided to a PC team indicating that the patient qualifies for PC. If no, then at step 3140, it is determined whether the patient has a minor illness. Examples of such minor illnesses are provided in FIG. 3B, by way of example and not limitation, and may include sickle cell disease, multiple sclerosis, acute stroke, COPD, alzheimer's disease/senile dementia, cardiomyopathy, decubitis ulcer (stage iii-iv), or ALS. After step 3140, method 3100 continues on FIG. 3C. With reference to FIG. 3C, if no at step 3140, then method 3100 ends at 3180 and the candidate patient is determined to not be in likely need of PC. If, however, step 3140 determines that the patient has a minor illness, then at step 3150, it is determined whether the candidate patient has a high utilization rate. For example, 3 or more impatient admissions in 6 months; 3 or more ED visits in 6 months; 2 or more inpatient admissions in 6 months for same DX ICU LOS of 3 days or more. If yes, then at step 3155, an alert is provided to a PC team indicating that the patient qualifies for a PC consult (i.e. the patient may qualify for a PC program). If no, then at 3160, it is determined whether the patient has at least one symptom. Example symptoms may include, without limitation, pain, tiredness, drowsiness, nausea, lack of appetite, sob, constipation, lack of wellbeing, or anxiety. If yes, then at step 3155, an alert is provided to a PC team indicating that the patient may qualify for a PC program and should receive a PC consult. If no, then at step 3170, method 3100 determines whether the candidate patient has a functional limitation of 50% or below. By way of example and not limitation, such functional limitations can include: reduced ambulation, full self care 70%; reduced ambulation, occasional self-care assist 60%; mainly sit/lie, considerable self care assist 50%; mainly lie, mainly self-care assistance 40%; totally bed bound, total care assist, normal or reduced intake 30%; totally bed bound, total care assist, minimal to sips intake 20%; totally bed bound, total care assist, mouth care only 10%. If yes, then method 3100 goes to step 3155 and an alert is provided to a PC team indicating that the patient may qualify for a PC program and should receive a PC consult. If no, then method 3100 ends at 3180 and the candidate patient is determined to not be in likely need of PC.

With reference now to FIGS. 3D-3F, a flow diagram illustrating a method 3200 for subdividing a set of PC patients using a stratification algorithm. As described above in step 304 of method 300, some embodiments of the invention stratify or subdivide PC patients. In particular, PC patients identified by method 3100 (FIG. 3B-3C) may be stratified or categorized based on (by way of example and not limitation) serious illness, by those who have already received PC consultation, by risk levels/scores/stages within a given condition, common assets (e.g. employment status, payer entity, religion, or income), conditional assets (e.g. ACE inhibitors, activity level, social isolation, etc.) or other means for separating or distinguishing PC patients from other PC patients.

At a high level, method 3200 receives patient(s) data 260, which may also include caregiver documentation, diagnoses, labs, meds, socioeconomic data, venue data (e.g. Acute care such as accessory documentation and physician documentation, ambulatory data such as physician documentation and output PC/rehab data, extended care data, or patient home data, for example), roles data (e.g., outpatient/inpatient data, PC/PT/Rehab data, ambulatory physician data, or home health nurse, for example), social networking data, or other available information about the patient. The PC patients may be stratified into a PC registry, which in one embodiment comprises a database of patients in a population. The stratification determined by method 3200 may be used for queuing PC patients for care, care planning, analytics, as well as determining stage or level of PC care, allocating resources, determining costs, providing granular reporting, or other uses facilitated from information about PC patient clusters. Furthermore, the determined strata of PC patients (or clusters of groups of similar PC patients) may be grouped for providing common level alerts, notifications, orders, cost estimates/analyses, resource forecasting, trigger care plans, or other services.

Some embodiments of method 3200 stratify or subdivide PC patients into multiple categories, which may overlap. For example, categories for New York Heart Association (NYHA), American Heart Associatin (AHA), ejection fraction, stages of conditions associated with the patients, or other example strata or categories described in the previous paragraphs. As shown in FIG. 3D-3F, method 3200 comprises three portions, corresponding to three stratifications determined for a PC patients: first portion 3200a corresponding to NYHA stratification (shown in FIG. 3D); a second portion 3200b corresponding to AHA stratification (shown in FIG. 3E), and a third portion 3200c corresponding to Ejection Fraction (shown in FIG. 3F).

Accordingly, method 3200 begins in portion 3200a (FIG. 3D) at step 3203 using patients in a particular health care registry of PC patients such as a heart failure (HF) registry or other registry. At step 3205, patient data optionally may be filtered based one or more criteria such as patient data from the prior year. At step 3210, it is determined whether discrete NYHA codes are available for the patient. If yes, then the respective NYHA stratification is used (step 3215) and method 3200 continues to portion 3200b (FIG. 3E). If no, then NYHA strata are determined. At step 3220, it is determined whether physician notes are available for NLP (natural language processing) or other physician data. If no, then method 3200 proceeds to portion 3200b. If yes, then at step 3225, symptomatic rest is assessed. If present, then the patient is assigned NYHA IV (at step 3227). If no, then at step 3230 symptomatic rest with minimal exertion is assessed. If yes, then the patient is assigned NYHA III at step 3232. If no, then at step 3235, symptomatic rest with moderate exertion is assessed, if yes, then patient is assigned NYHA II at step 3237. If no, then at step 3240, the patient is determined to be asymptotic. At step 3242, those patients are assigned NYHA I. Method 3200 then continues to portion 3200b in FIG. 3E.

At step 3245, it is determined whether discrete AHA codes are available. If yes, then the respective AHA stratification is used (step 3250) and method 3200 continues to portion 3200c (FIG. 3F). If no, then AHA strata are determined. At step 3255, it is determined whether physician note/NLP data is available. If no, then method 3200 proceeds to portion 3200c. If yes, then at step 3260, structural HD is assessed. If it is present, then at step 3262, the patient is assigned AHA A. If not, then at step 3265 it is determined whether symptoms are minimal or non-existent. If yes, then at step 3267, the patient is assigned AHA B. If not, then at step 3270 it is determined whether symptoms are managed with therapy. If yes, then at step 3272, the patient is assigned AHA C. If not, then at step 3275 it is determined that the patient has symptomatic HD, which does not respond to therapy, and the patient is assigned AHA D. Method 3200 then continues to portion 3200c in FIG. 3F.

At step 3280, prior year patient data is filtered out from available patient data (if not already filtered at step 3205). At step, 3282 it is determined whether an echo has been performed. If no, then at step 3283 it is determined whether NV has been performed. If no, then method 3200 ends at 3299. If step 3283 is yes or if step 3282 is yes, then method 3200 continues to step 3284. At step 3284, it is determined whether there are ejection fraction (EF) heart failure measurement quantitative results. If no, then at step 3285, it is determined whether there are EF qualitative results. At step 3287, it is determined whether there is no systolic dysfunction. If there is not, then method 3200 proceeds to step 3296 the patient is categorized as preserved EF. If there is systolic dysfunction at step 3287, then the systolic dysfunction is assessed. At step 3289, it is determined whether the systolic dysfunction is mild. If it is mild, then at step 3294 the patient is categorized as moderate EF. If not, then at step 3290, the patient is determined to have moderate or severe systolic dysfunction and at step 3292, the patient is categorized as reduced EF. Returning to step 3284, if there are quantitative EF results, then method 3200 proceeds to step 3286. At step 3286, if the EF is greater than 55%, then at step 3296 the patient is categorized as preserved EF. If EF is less than or equal to 55%, then method 3200 proceeds to step 3288. If EF is greater than 40%, then at step 3294 the patient is categorized as moderate EF. If EF is less than or equal to 40%, then at step 3292 the patient is categorized as reduced EF.

With reference now to FIG. 3G, a flow diagram illustrating a method 3300 for PC prediction is provided. As described in connection to step 306 of method 300, PC patients may be prioritized by predicting those patients likely to need specific PC care and forecasting when those patients are likely to need the care. At step 3305 it is determined whether a candidate PC patient is in an inpatient setting. If no, then method 3300 ends at step 3399. If yes, then at step 3310, readmission prediction is determined. At step 3312, HF readmission stage 1 is assessed. At step 3314, HF readmission stage 2 is assessed. And at step 3316, the outcome is normalized at low, medium, or high (or a similar normalization scale, such as 1 to 5). At step 3315, lighthouse readmissions/APP/transitions of care are evaluated. At step 3317, the outcome of step 3315 is normalized to low medium or high (or a similar normalization scale). At step 3320, boost protocols are assessed. At step 3330, care team view or risk may be updated and care team may be notified, if necessary. The care team may be provided risk for all cause readmissions as well as for heart failure (HF) readmission. At step 3340, care management workflow is prioritized based. At step 3350, provider workflow is forecasted. Method 3300 ends at step 3399.

Turning now to FIGS. 4A-4K, a series of flow charts, user-interfaces, and workflows are provided relating to PC program implementation. It is contemplated that the user interfaces (including patient portal shown in FIG. 4G) and workflows may be presented to a caregiver or user via user interface(s) 280. With reference to FIG. 4A, a flowchart illustrating a method 400 is provided for PC program implementation. Embodiments of Method 400 are intended to function as ordered goals for one or more software agents or routines implementing a PC program. At step 402, method 400 provides consistent utilization of information. In some embodiments, this includes applying standard identification or recognition processes for PC patients, such as described in connection to method 3100, and may further include providing notifications, triggers or queuing, and situational awareness. Examples of features, applications, and interfaces that facilitate the goal of step 402 are provided in connection to FIGS. 4B-4F and method 4800 in FIG. 4J. At step 404, improve quality and treatment compliance. Examples of features, applications, and interfaces that facilitate the goal of step 404 are further described in connection to FIGS. 4B-4G and method 4800 in FIG. 4J. At step 406, enable cohort and patient specific surveillance. Examples of features, applications, and interfaces that facilitate the goal of step 404 are further described in connection to FIGS. 4B-4G.

With reference to FIG. 4B, an example user interface depicting significant events is shown. Embodiments of a significant events user interface may comprise a patient specific window to allow surveillance, discrimination, and reporting of condition related events. Further, in some embodiments, a significant events user interface may provide pooling of patient specific notifications from multiple venues, indicate an event or “situation” has occurred or may occur without dependency on a workflow interruption, and/or may display and associate pertinent data with the identified event. The particular example significant events user interface shown in FIG. 4B may correspond to the following intervention data. Interventions to be accomplished by: Day 1: Pain Assessment; Pain Score less than or equal to 3 (1 to 10 scale) met; Identification of Health Care Proxy/Surrogate decision maker; Resuscitation Status documented; Advance Directive in place; PC Information—Written leaflet handed over to family. Day 3: Social Consult documented; Spiritual Consult documented. Day 5: Interdisciplinary Family Meeting documented; Identification of Family Meeting Room.

Some embodiments may further include a user interface associated with a patient condition module (such as a condition module(s) 244 of FIG. 2), which provides a patient-specific window to allow clinicians to monitor specific issues and see the “story” of an individual patient. For example, such user interfaces may focus on current personalized care plan elements (i.e. nutrition, activity, medications, labs, current and future appointments) or may expose the output of algorithms from prediction and stratification (or allow manual control over stratifications). Similarly, some embodiments may further include a user interface associated with a patient situation module (such as a situation module(s) 246 of FIG. 2), which provides a patient-specific window to allow surveillance, discrimination, and reporting of condition related events. For example, like the significant events user interface, the situation module user interface may allow pooling of patient specific notifications from multiple venues, may indicate an event or situation has occurred or may occur without dependency on a workflow interruption, and/or may display and associate pertinent data with the identified event. Additionally, some embodiments of the situational module user interface may allow end users to “flag” or communicate an identified event to other providers.

Turning to FIG. 4C, an example interdisciplinary plan of care (IPOC) workflow is shown. This example IPOC workflow may include best practice checklist items (including across venues), patient goals (which may be adjusted as needs change), and interventions such as consults, preselected interventions, and met/not-met outcomes. With reference to FIGS. 4D and 4E, examples of IPOC encounter specific outcomes and interventions (FIG. 4D) and non-encounter specific outcomes and interventions (FIG. 4E) are provided. Turning now to FIG. 4F, an example user interface for PC intervention for complex CDS is shown. This example user interface may be generated and used by a PC consulting advisor for providing point of care decision support with evidence based timing for PC recommendations. Further some embodiments may include functionality for lab trending.

With reference again to FIG. 4G, an example user interface for a patient portal is shown. Embodiments of the patient portal interface may be generated by patient portal(s) component 248 of FIG. 2. In some embodiments, such interfaces may function as a primary transactional system for persons within population health, and allow patients to view their data and the outputs of some of the program algorithms (like stratifications). Further, embodiments of the patient portal user interface can facilitate the patient to be able to input additional data into the system, especially through the use of home devices. Additionally, patient portals may be used with PC programs for engaging patients in their assigned education or workshops as well as exposing their specific measures or health goals.

Turning now to FIGS. 4H and 4I, a series of flow diagrams are provided illustrating methods 47000 for providing transitions management to heart failure (HF) patients. Example methods 47000 comprise method 47100 for transportation (FIG. 4H), method 47200 for medication (FIG. 4H), and method 47300 for other services (FIG. 4I.). With reference to method 47100, at step 47110 a provider list is generated or otherwise received (if it is already generated). At step 47120 it is determined whether the patient has transportation needs. If no, then method 47100 proceeds to step 47155 where an appointment for the patient may scheduled. (The appointment may be scheduled because the patient presumably is able to transport himself or herself to the appointment.) If yes, then at step 47130 it is determined whether insurance will cover transportation services. If yes, then method 47100 proceeds to step 47155 where an appointment then may be scheduled. If no, then at step 47140 it is determined whether there are community/organization/free transportation services available. If yes, then method 47100 proceeds to step 47155 where an appointment may be scheduled. If no, then at step 47150 it is determined whether other resources may be available that have not already been identified. If yes, then method 47100 proceeds to step 47155 where an appointment may be scheduled. If no, then at step 47160, it is determined whether other resources are available that have not been identified. If no, yes, then at step 47165 those services are arranged for the patient. If no, then at step 47175, the appointment is not scheduled until transportation is available.

With reference to method 47200, at step 47210 patient medication follow-up is determined. At step 47215 it is determined whether the patient can access prescriptions. If yes, then at step 47220 prescriptions may be sent to a pharmacy and the patient notified that the prescriptions are available for pickup when ready. At step 47235 it is determined whether the patient can access the pharmacy. If no, then at step 47240 it is determined whether the pharmacy can deliver. If yes, then the patient is provided the medications at step 47260. If no, then at step 47250 an online or alternative pharmacy is identified so that the patient may receive medications (at step 47260). Returning to step 47215, id the patient cannot access prescriptions, then at step 47225, it is determined whether there is a PAP. If yes, then at step 47230, an application is submitted for PAP, and method 47200 proceeds to step 47265. If no, then at step 47265 it is determined whether samples are available. If yes, then at step 47270 samples of PAP information are provided. If no, then at step 47275, it is determined whether there is a CBO who provides assistance. If yes, then at step 47280 a referral to the CBO is initiated. If no, then at step 47290 care management absorbs the cost of medications in the short term.

With reference to method 47300, at step 47310 other services are determined. At step 47320 it is determined whether additional referrals are required. If no, then method 47300 ends at 47399. If yes, then at step 47330, other services are assessed. These other services may comprise (by way of example and not limitation) support groups, nutrition/dietary consults, outpatient cardiac rehabilitation, physical activity access, or educational services. At step 47340, it is determined whether insurance will cover the other services. If yes, then at step 47370 a referral is sent for the other service(s). If no then at step 47350, it is determined whether there are free services available. If yes, then at step 47370 a referral is sent for those free other service(s). If no, then at step 47360, the patient is educated as a last resort. At step 47380, where a referral has been initiated, the patient is educated per services arranged. Patient access and understanding may also be verified. At step 47390 a transportation workflow is generated or updated, and method 47300 ends at step 47399.

Turning now to FIG. 4J, a flow diagram is provided illustrating a method 4800 for determining referral need. Some embodiments of method 4800 may be designed to run automatically in the background and may determines whether or not a suggestion will be made to the user as to running the assignment/referral algorithm. For example, where method 4800 determines that a stage chart failure patient does not have a cardiologist, a message can be triggered to the user suggesting that they run the assignment/referral process. At step 4810, it is determined that a given patient is in the HF registry or pre-HF registry. At step 4815, it is determined whether the patient has PCP. If yes, then at step 4825, it is determined whether the patient is stratified as BII-BIV, C, or D. If yes, then at step 4835, it is determined whether the patient has a cardiologist. If yes, then at step 4845, it is determined whether the patient has had a cardio outpatient encounter during the previous year. If yes, then method 4800 ends at step 4899. If no, then at step 4855, it is determined whether a referral agent (or routine) ran for the user/patient combo in the last 30 days. If yes, then method 4800 ends at step 4899. If no, then at step 4880 a referral agent is suggested.

Returning to step 4815, id the patient does not have PCP, then method 4800 proceeds to step 4855 (described above). Returning to step 4825, if the patient is not stratified as BII-BIV, C or D, then at step 4830, the patient is stratified as A or BI. At step 4840, patient acute hospital admission during the prior two years is assessed. Acute hospital admission may be assessed (step 4850) for conditions including (by way of example and not limitation) pulmonary edema, new onset A-Fib. HF, CABG, AMI, valvular disease, or cardiomyopathy. At steo 4865, it is determined whether the patient has had more than one acute hospital readmission. IF no, then method 4800 ends at step 4899. If yes, then method 4800 proceeds to step 4835, which is described previously.

Turning now to FIG. 4K, a flow diagram is provided illustrating a method 4900 for determining assignment. In some embodiments, method 4900 outputs sorted and/or filtered list(s) of providers based on location, payor, and language. At step 4905, HF stratification is determined. Where the HF stratification is stage B/C/D or reduced EF, then method 4900 proceeds to step 4945. Otherwise, method 4900 proceeds to step 4910. At step 4910, it is determined whether the patient has PCP. If yes, then at step 4915, PCP is included in an provider list and designated “current PCP.” Method 4800 then proceeds to step 4920. If no, then at step 4920, record systems may be queried for PCP providers. At step 4925, conduct a primary sort of the list of PCP providers by payor compatibility. At step 4930, conduct a secondary sort of PCP provider list by language compatibility. At step 4935, conduct a tertiary sort of PCP provider list by location compatibility. At step 4940, generate the list of PCP providers for best match to the patient. Method 4900 proceeds to step 4980.

Returning to step 4945, it is determined whether the patient has a cardiologist. If yes, then at step 4950, the cardiologist is included atop of the provider list and designated “current cardiologist.” Method 4900 then proceeds to step 4955. If no at them 4945, when at step 4955, record systems may be queried for cardiologist providers. At step 4960, conduct a primary sort of the list of cardiologist providers by payor compatibility. At step 4965, conduct a secondary sort of cardiologist provider list by language compatibility. At step 4970, conduct a tertiary sort of cardiologist provider list by location compatibility. At step 4975, generate the list of cardiologist providers for best match to the patient. Method 4900 proceeds to step 4980.

At step 4980, generate a notification to the user including the top 10 providers. At step 4985, designations for PCP and cardiologists may be included in the notification. At step 4990 additional appropriate rationale on a provider basis may also be included in the notification. At step 4995, an option to view the “next 10” providers may also be included in the notification. Method 4900 ends at step 4999.

Turning now to FIGS. 5A-5C, a flow chart and example user-interfaces of worklists are provided relating to managing a population of PC patients. With reference to FIG. 5A, a flowchart illustrating a method 500 is provided for managing care of PC-patient populations. Embodiments of method 500 are intended to function as ordered goals for one or more software agents or routines for providing PC management services. At step 502, method 500 monitors events in a population of PC patients. Embodiments of step 502 comprise monitoring and analyzing events, including significant events, in the population. In particular, embodiments of step 502 utilize outputs from predictions for analyzing value, resourcing, and costs. Additionally, some embodiments of step 502 may measure and report value, outcomes, and discovery.

Turning briefly to FIGS. 5B, 5C, and 5D, three example PC worklists are provided, which may be used to facilitate the objectives of step 502 of method 500. Embodiments of PC worklists may be generated by worklist(s) component 242 (described in FIG. 2) based on method 3100 or similar algorithms that identify persons for PC. Worklists facilitate creating a list of persons for a care manager. From the worklist a care manager can access other application elements such as patient-specific user interfaces (e.g. condition module or situation module user interfaces for various conditions or situations). Further, some embodiments of worklists provide a dynamic listing of patients from the PC population across the continuum of care. Some embodiments further include patient filters enabling care providers or other users to create custom worklists including a precise set of patients meeting specific criteria, such as demographic factors, type and severity of disease, non-compliance risk, and locality. Moreover, some embodiments of worklists support actionable decision support tools for assisting users in care of the PC populations.

Returning to method 500, at step 504, method 500 reconciles outcomes contradictions and unifies recommendations. In some embodiments, step 504 comprises determining the status of objectives and outcomes, resolving conflicts (e.g. preventing intra and inter program contradictions) or flagging potential conflicts, and unifying recommendations to streamline care. At step 506, method 500 assigns attribution. In some embodiments, method 506 further comprises allocating appropriate content to individual patients, assigning appropriate care team resources, and evaluating credit for care quality and measurement.

At step 508, method 500 determines future capacity and/or availability. In some embodiments, step 508 includes determining capacity and availability based on current utilization and one or more prediction models (such as described in connection to step 306 of method 300 and method 3300). Some embodiments of step 508 further adjust for predicted and observed needs, such as my updating workflows, and incorporate supply and workforce management systems.

Many different arrangements of the various components depicted, as well as components not shown, are possible without departing from the spirit and scope of the present invention. Embodiments of the present invention have been described with the intent to be illustrative rather than restrictive. Alternative embodiments will become apparent to those skilled in the art that do not depart from its scope. A skilled artisan may develop alternative means of implementing the aforementioned improvements without departing from the scope of the present invention.

It will be understood that certain features and subcombinations are of utility and may be employed without reference to other features and subcombinations and are contemplated within the scope of the claims. Not all steps listed in the various figures need be carried out in the specific order described. Accordingly, the scope of the invention is intended to be limited only by the following claims.

What is claimed is:

1. A method for determining a population of human patients that qualify for palliative care, comprising:
accessing an electronic medical record for each candidate patient in the population of patients;
analyzing the electronic medical record of the candidate patient to determine that the candidate patient has at least a major or minor serious illness;
if each candidate patient has a major illness, then updating the electronic medical record to indicate that the patient is qualified for receiving a palliative care program thereby qualifying the candidate patient for palliative care;
if each candidate patient has a minor illness, then:
a) determining a utilization rate for the candidate patient;
b) determining that the patient has at least one symptom of the group comprising: pain, tiredness, drowsiness, nausea, lack of appetite, SOB, constipation, lack of wellbeing, and anxiety;
c) determining a functional limitation of the candidate patient;
d) determining that the candidate patient qualifies for palliative care based on the utilization rate, the candidate patient having at least one of the symptoms, or the patient having a functional limitation at or below fifty percent; and
e) updating the electronic medical record to indicate that the patient is qualified for receiving a palliative care program thereby qualifying the candidate patient for palliative care.

2. The method of claim 1, further comprising:
modifying a healthcare software program for facilitating implementation of the palliative care program for the candidate patient, the modification based on the indication in the electronic medical record that the patient is qualified for receiving the palliative care program; and
executing the health care software program on a computer system associated with a health care provider.

3. The method of claim 2, wherein the healthcare software program comprises one or more software agents, and the computer system comprises a multi-agent multi-agent operating system.

4. The method of claim 2 further comprising determining a palliative care stratification for the candidate patient and further modifying the healthcare software program based on the determined stratification.

5. The method of claim 1 further comprising issuing an alert to a caregiver indicating that the candidate patient qualifies for a palliative care program.

6. The method of claim 1 further comprising automatically enrolling the candidature patient in a palliative care regimen.

7. The method of claim 1 further comprising allocating healthcare resources for the palliative care program for the candidate patient.

8. The method of claim 6, wherein allocating health care resources comprises:
accessing a healthcare resource monitoring computer program routine; and
modifying the resource monitoring computer program routine to include resources designated for the palliative care program for the candidate patient;

9. The method of claim 1, wherein the candidate patient qualifies for palliative care where the determined utilization rate is least one of: three or more inpatient admissions within the previous six months, three of more emergency department visits in the previous six months, and two or more inpatient admissions within the previous six months for the same diagnosis including a loss of three or more days of work.

10. The method of claim 1, wherein the minor illness comprises one or more of sickle cell disease, multiple sclerosis, acute stroke, COPD, Alzheimer's disease, senile dementia, cardiomyopathy, decubitus ulcer (stage III-IV), or ALS.

11. The method of claim 1, wherein the major illness comprises one or more of Stage 3-4 CHF, AIDS, ESRD & Stage IV/V kidney disease, end stage liver disease, cirrhosis, liver failure, hepatitis B, metastatic/recurrent/stage-IV cancers, traumatic brain injury, cardiac arrest, SHD/SAH/ICH, vent status of five or more days, or tracheostomy/tracheotomy status.

12. The method of claim 1, wherein the functional limitation further comprises one or more of the group comprising: (a) at least seventy-percent reduced ambulation or full self-care; (b) at least sixty-percent reduced ambulation or occasional self-care assistance needed (c) mainly sitting or lying, or considerable self-care assistance needed (at least fifty-percent); (d) mainly lying or mainly self-care assistance needed (at least forty-percent); (e) totally bed-bound, total care assistance required and normal or reduced intake by at least thirty percent; (f) totally bed-bound, total care assistance required and minimal to sips intake by at least twenty percent; and (g) totally bed-bound, total care assistance required and mouth care only by at least ten percent.

13. One or more computer-readable storage devices having computer-executable instructions embodied thereon that, when executed by one or more processors, determine a computer program for implementing palliative care plans according to palliative care classifications, the method comprising:
classifying a set of patients in a healthcare registry according to a palliative care stratification algorithm thereby determining a plurality of patient subsets, each patient subset corresponding to a palliative care class;
accessing a healthcare software program for facilitating implementation of a palliative care program;
modifying the healthcare software program based on the classification, the modification of the healthcare software program including generating computer instructions corresponding to a set of palliative care plans, each plan associated with at least palliative care class;
executing the health care software program on a computer system associated with a health care provider.

14. The one or more computer-readable storage devices of claim 13, wherein the healthcare registry comprises a heart-failure registry and wherein palliative care stratification algorithm comprises, for each patient in the set of patients:
classifying the patient according to NYHA classes, if discrete NYHA codes are available for the patient;
if discrete NYHA codes are unavailable for the patient, classifying the patient using caregiver observational data, wherein the patient is classified as: (i) NYHA I, if the patient is asymptomatic; (ii) NYHA II, if the patient is symptomatic with moderate exertion; (iii) NYHA III, if the patient is symptomatic with minimal exertion; and (iv) NYHA IV, if the patient is symptomatic at rest; and
modifying an electronic medical record associate with the patient to indicate the patient's classification.

15. The one or more computer-readable storage devices of claim 13, wherein the healthcare registry comprises a heart-failure registry and wherein the palliative care stratification algorithm comprises, for each patient in the set of patients:
classifying the patient according to NYHA classes, if discrete NYHA codes are available for the patient;
if discrete NYHA codes are unavailable for the patient, classifying the patient according to AHA classes, if discrete AHA codes are available for the patient;
if discrete AHA codes are unavailable for the patient, classifying the patient using caregiver observational data, wherein the patient is classified as: (a) AHA A, if the patient exhibits no evidence of structural heart disease; (b) AHA B, if the patient exhibits minimal or nonexistent symptoms of heard disease; (c) AHA C, if the patient symptoms of heart disease are managed with therapy; and
(d) AHA D, if the patient is symptomatic of heart disease which does not respond to therapy; and
modifying an electronic medical record associate with the patient to indicate the patient's classification.

16. The one or more computer-readable storage devices of claim 15, further comprising:
accessing the electronic medical record (EHR) associated with the patient;
based on the EHR, determining information in the EHR indicating an ejection fraction (EF) was performed on the patient within the previous 12 months, the information including quantitative EF results or qualitative results for the EF;
if the EHR includes quantitative results for the EF, then classifying the patient as preserved EF where the EF is greater than fifty-five percent; classifying the patient as moderate EF, where the EF is between forty and fifty-five percent, and classifying the patient as reduced EF, where the EF is less than forty-percent;
if the EHR includes qualitative results for the EF, then classifying the patient as preserved EF where the patient has no systolic dysfunction; classifying the patient as moderate EF, where the patient has “mild” systolic dysfunction, and classifying the patient as reduced EF, where the patient has “moderate” or “severe” systolic dysfunction; and
further modifying an electronic medical record associate with the patient to indicate the patient's EF classification.

17. One or more computer-readable storage devices having computer-executable instructions embodied thereon that, when executed by one or more processors, determine a palliative care referral computer program for determining a palliative care referral need for a patient in a health care registry for heart failure or pre-heart failure, the method comprising:
if the patient does not have a primary care physician (PCP), then
a) determining that a referral notification has not issued within thirty days and generating a referral notification using the palliative care referral computer program;
if the patient does have a PCP, then
a) accessing an electronic medical record (EHR) associated with the patient;
b) if the EHR indicates patient is classified as NYHA II-BIV or AHA C-D and the patient does not have a cardiologist, then determining that a referral notification has not issued within thirty days and generating a referral notification using the palliative care referral computer program;
c) if the EHR indicates patient is classified as NYHA II-BIV or AHA C-D and the patient has a cardiologist, then
i. determining that the patient has not had a cardio outpatient in the last 12 months;
ii. determining that a referral notification has not issued within thirty days; and
iii. generating a referral notification using the palliative care referral computer program;
d) if the EHR indicates patient is classified as NYHA I or AHA A, then
i. determining that the patient has had an acute hospital admission during the prior two years;
ii. if the patient does not have a cardiologist, then
(1) determining that a referral notification has not issued within thirty days and generating a referral notification using the palliative care referral computer program;
iii. if the patient has a cardiologist, then
(1) determining that the patient has not had a cardio outpatient in the last 12 months;
(2) determining that a referral notification has not issued within thirty days; and
(3) generating a referral notification using the palliative care referral computer program.

18. The one or more computer-readable storage devices of claim 17, further comprising:
providing the generated referral notification to a healthcare entity associated with the patient;
storing in a computer memory accessible by the one or more processors executing the palliative care referral computer program, information indicating a date that the generated referral notification was provided.

19. The one or more computer-readable storage devices of claim 17, wherein the palliative care referral computer program executes in the background of a clinical decision support computer system.

20. The one or more computer-readable storage devices of claim 17, wherein determining that the patient has had an acute hospital admission during the prior two years comprises determining that the patient has been admitted within two years for at least one of pulmonary edema, new onset A-fibrillation, heart failure, coronary artery bypass grafting, Acute Myocardial Infarction, valvular disease, and cardiomyopathy.
